(19) United States
(12) Patent Application Publication
(10) Pub. No.: US 2015/0045054 A1
(43) Pub. Date: Feb. 12, 2015

(54) Systems and Methods for Floor Determination of Access Points in Indoor Positioning Systems

(71) Applicant: QUALCOMM Incorporated, San Diego, CA (US)

(72) Inventors: Amir Abbas Emadzadeh, Campbell, CA (US); Weihua Gao, San Jose, CA (US); Sai Pradeep Venkatraman, Santa Clara, CA (US); Sundar Raman, Fremont, CA (US); Ju-Yong Do, Palo Alto, CA (US); Gengsheng Zhang, Cupertino, CA (US)

(73) Assignee: QUALCOMM Incorporated, San Diego, CA (US)

(21) Appl. No.: 13/963,891

(22) Filed: Aug. 9, 2013

(51) Int. Cl. H04W 4/04

(52) U.S. Cl. CPC H04W 4/043
USPC 455/456.1

(57) ABSTRACT

Systems and methods are disclosed for determining the floors on which APs are located for WiFi-based indoor positioning systems. A data collection phase is followed by a data analysis phase. During data collection, measurement data to observed APs may be collected from various locations on different floors. The measurements data may include received signal strength indication (RSSI), optional round-trip-time (RTT) data to the APs, and floor information of the measurement locations. Measurement data may also be collected from crowd sourced data without floor information of the measurement locations. In data analysis, the collected measurement data are analyzed using various algorithms to determine if APs belong to the same floor and to assign APs on the same floor to the same cluster. APs on different floors may thus be assigned to different clusters. If the floor information of the measurement locations is known, each cluster may be assigned a floor number.

### TECHNICAL FIELD

This application generally relates to wireless communication. In particular, this application relates to methods and systems to determine the floors on which access points of an indoor positioning system are located.

### BACKGROUND

Many services and applications require knowledge of a position of mobile devices when the mobile devices are operated indoor. For example, organizers of indoor events or merchants in indoor shopping malls may offer event attendees or shoppers service or product information based on the locations of mobile devices. While GPS receivers have been fairly successful in providing a low-cost solution for position determination, GPS signals suffer severe attenuation when the receivers are operated indoor. With the prevalence of wireless local area networks (WLAN) such as WiFi networks, WLAN signals have increasingly been used to determine a position of mobile devices that operate indoor. In conventional WiFi-based positioning systems, a mobile device may measure the strength of received WiFi signals from multiple access point (APs) to estimate the ranges to the access points, i.e., using a received signal strength indication (RSSI). Alternatively, a mobile device may estimate the ranges to APs by measuring a round-trip time (RTT) between the mobile device and the APs using WiFi-based signal exchanges. These systems generally require knowledge of the locations of the APs to generate a position of the mobile device using techniques such as trilateration. When information on the locations of the APs are not available, a WiFi-based positioning system may compile a map of estimated RSSI and/or RTT data with respect to a group of APs for a matrix of discrete locations. This map, called a heat map, may be generated for a matrix of interconnected positional nodes of the indoor venue from actual RSSI and/or RTT measurements taken at a few strategic locations and may be stored by a system server. The locations of the matrix of interconnected positional nodes may be referred to as a connectivity map. To derive a position of a mobile device, a mobile device may periodically measure RSSI and/or RTT data with respect to observed APs. The mobile device may transmit the measured data to the system server. The system server may use techniques such as particle filters to process the measured data in light of the heat map and the connectivity map to estimate a position for the mobile device. For example, the measured RSSI and/or RTT data to the observed APs may be compared with the estimated RSSI and/or RTT data of the heat map for a subset of the observed APs to estimate a position near a node of the connectivity map. The system server may transmit the estimated position of the mobile device back to the mobile device as assistance data.

For the indoor positioning system to generate the heat map for the nodes of the connectivity map for an indoor venue, an operator of the WiFi-based positioning system may measure the RSSI and/or RTT with respect to observed APs from multiple strategic locations in the venue. The system server may process the measured data for the measurement locations to generate the heat map with respect to all or a subset of the observed APs for the nodes in the connectivity map. Frequently, not all APs may be suitable for use by a WiFi-based indoor positioning system. For example, some APs are mobile or have signals that are too weak. Even if the APs have good signal strength, the geometry of the APs may not make them suitable for use in a positioning system. For example, APs that are clustered together may provide worse positioning performance compared to a few APs that are more geometrically distributed. In fact, poorly distributed APs may increase the computational cost of generating the heat map with respect to these APs. Poorly-distributed APs may also increase the computational cost on the system server of estimating positions of mobile devices using the heat map generated with respect to these APs. Therefore, a key step in setting up WiFi-based positioning systems is the selection of the set of APs to use in generating heat maps. Furthermore, when an indoor venue has multiple floors, the selection of the APs may require knowledge of the floors on which the APs are located. This is because in 3-D WiFi-based positioning systems (i.e., systems that generate altitude/floor positions for the mobile devices), the signals received at the mobile devices are generally the strongest when they are received from APs that are on the same floor as the mobile devices. Therefore, it is desirable to assign APs located on the same floor to a cluster for use in generating the heat map for that floor. Different clusters of APs may be selected for generating the heat maps for different floor. The positioning system may use the heat map for the floor containing the AP observed by the mobile device to have the strongest signal strength to determine the 3-D position of the mobile device. In this regard, if an AP is assigned to the cluster for the wrong floor, the indoor positioning system may generate erroneous floor position estimates for mobile devices. As such, there is a need for 3-D WiFi-based indoor positioning systems to determine the floors on which APs are located so that the proper set of APs may be selected for generating heat maps and for accurately determining the 3-D positions of mobile devices on different floors.

### SUMMARY

Systems and methods are disclosed for determining the floors on which APs are located for WiFi-based indoor positioning systems. The systems and methods of the present disclosure may include a data collection phase followed by a data analysis phase. During the data collection phase, measurement data to observed APs may be collected from different locations and different floors. The measurements data may include the RSSI and RTT data to the APs, the media access control (MAC) addresses of the APs, as well as the location, including the floor number, and the time at which each measurement is taken. In one or more embodiments, measurement data may be collected from crowd sourced data. Crowd sourced data are data collected by individual mobile devices of the public and communicated to APs. Crowd sourced data may also include the RSSI and RTT data to the APs, the MAC addresses of the APs, and the time at which each measurement is taken. However, crowd sourced data do not have the locations at which the measurements were taken. The large amount of measurement data collected by many mobile devices in the crowd sourced data may be leveraged during the data analysis phase to increase the reliability of the floor assignment of the APs.

During the data analysis phase, the data collected from the data collection phase are analyzed to assign a floor number to each observed AP. When the collected data includes location information, such as the floor number of the measurement points, the data may be analyzed to assign a floor number to each observed AP. When the collected data does not include location information of the measurement points, the data may be analyzed to determine the APs that belong to the same floor and to assign APs belonging to the same floor to the same cluster. APs on different floors may thus be assigned to different clusters. To assign a floor number to a cluster of APs, the floor number of an AP from the cluster may be determined. This may be accomplished by analyzing additional data containing floor number of the measurements points from which the floor number of any one AP in the cluster may be determined.

A method for clustering APs of a communication network is disclosed. The method includes receiving by a processor data measurements with respect to a number of APs of the communication network taken at different measurement points. The method also includes assigning each of the APs to one of a number of clusters based on the data measurements. Each cluster has one or more member APs. The member APs in each of cluster are determined to be on the same floor.

An apparatus to cluster APs of a communication network is disclosed. The apparatus includes a memory, and one or more processors that read the memory. The processors are configured to receive data measurements with respect to a number of APs of the communication network taken at different measurement points. The processors are also configured to assign each of the APs to one of a number of clusters based on the data measurements. Each cluster has one or more member APs. The member APs in each cluster are determined to be on the same floor.

A non-transitory computer-readable medium that stores machine-readable instructions for execution by processors are disclosed. The processors read the instructions to perform steps for clustering APs of a communication network. The instructions include steps to receive data measurements with respect to a number of APs of the communication network taken at different measurement points. The instructions also include steps to assign each of the APs to one of a number of clusters based on the data measurements. Each cluster has one or more member APs. The member APs in each cluster are determined to be on the same floor.

A system for clustering APs of a communication network is disclosed. The system includes means for receiving data measurements with respect to a number of APs of the communication network taken at different measurement points. The system also includes means for assigning each of the APs to one of a number of clusters based on the data measurements. Each cluster has one or more member APs. The member APs in each cluster are determined to be on the same floor.

### BRIEF DESCRIPTION OF THE DRAWINGS

FIG. 1 shows a floor plan view of an indoor venue that has three floors where APs of a WiFi network are deployed for which the floor number of the APs is determined according to one or more embodiments of the subject matter of the present disclosure;

FIG. 2 shows a data collection phase in which measurement data to observed APs are collected at various measurement points along a path according to one or more embodiments of the subject matter of the present disclosure;

FIG. 3 shows crowd sourced data collected by individual mobile devices as part of a data collection phase according to one or more embodiments of the subject matter of the present disclosure;

FIG. 4 shows a method for determining the floors on which APs of a WiFi network are located according to one or more embodiments of the subject matter of the present disclosure;

FIGS. 4A and 4B show a method for analyzing collected data to assign observed APs determined to be on the same floor to a cluster according to one embodiment of the subject matter of the present disclosure;

FIG. 5 shows a method for analyzing collected data to determine if two APs are on the same floor or on different floors according to one embodiment of the subject matter of the present disclosure;

FIG. 6 shows another method for analyzing collected data to determine if two APs are on the same floor or on different floors according to one embodiment of the subject matter of the present disclosure;

FIG. 7 shows a method for analyzing the collected data to determine if two measurement points are on the same floor or on different floors according to one embodiment of the subject matter of the present disclosure; and

FIG. 8 is a block diagram of a computer system 800 suitable for implementing the method to analyze collected data to assign APs of a WiFi network to floor clusters or to assign floor numbers to APs according to one embodiment of the subject matter of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed for determining the floors on which APs are located for WiFi-based indoor positioning systems. APs may be deployed on different floors in an indoor venue. The systems and methods of the present disclosure may include a data collection phase followed by a data analysis phase. During the data collection phase, measurement data to observed APs may be collected from different locations in the indoor venue. For example, a data collector may use a mobile device to record RSSI and RTT measurements from observed APs at various measurement points, the MAC addresses of the APs, the location, including the floor number, and the time at which each measurement is taken. The locations of the measurement points may include strategic points or other accessible locations in the indoor venue, such as in the corridors and close to the entrance of the shops of an indoor mall. The measurement points may be located along predefined paths and may include measurement points on the stairs between floors.

In one or more embodiments, measurement data may be collected from crowd sourced data. Crowd sourced data are data collected by individual mobile devices of the public. Crowd sourced data may be communicated from the mobile devices to the APs for recording. For example, APs may record RSSI and RTT measurements taken by mobile devices with respect to observed APs, the time at which the measurements were taken, and the MAC addresses of the observed APs. However, unlike the data collected by data collectors at known measurement locations, crowd sourced data do not include information on the locations, such as the floor number, at which the measurements were taken. To protect the privacy of users, the data also do not include the identity of the mobile devices. A system server of the indoor positioning system may obtain the crowd sourced data from the APs for data analysis.

During the data analysis phase, the data collected from the data collection are analyzed to assign a floor number to each observed AP. For example, when the data are collected from different locations by data collectors using mobile devices, the system server of the indoor positioning system may receive the data from the mobile devices to perform data analysis. In one or more embodiments, mobile devices that collect the data may run the data analysis. The data including the RSSI and RTT measurements from observed APs taken at various measurement points, the MAC addresses of the APs, and the floor number of the measurement points may be analyzed to assign the APs to floor clusters. Each floor cluster may contain APs for a specific floor. The system server or the mobile devices may analyze the data iteratively after the data on each floor are collected to assign a floor number to the observed APs in the collected data. As more data are collected from additional floors, the additional data may be analyzed to assign a floor number to newly observed APs and also to refine the floor assignment of previously assigned APs.

For crowd sourced data where no floor information is associated with the collected data, the system server may analyze the entire crowd sourced data or a subset of the data, such as measurement taken from a specific time, to assign APs to floor clusters. For example, the system server may analyze the RSSI and RTT data to the APs, and the MAC addresses of the APs to identify APs that belong on the same floor. APs that belong on the same floor are assigned to the same floor cluster. However, floor numbers may not be assigned to the floor clusters because the crowd sourced data analyzed to determine the floor clusters do not contain floor information of the measurement points. To assign a floor number to a floor cluster, additional data containing floor information of the measurement points, such as those collected by data collectors, may be analyzed to determine the floor number of any one of the APs in the floor cluster.

The indoor positioning system may use APs in the cluster for a floor and the locations associated with the measurement data to generate the heat map for the nodes of the connectivity maps with respect to the APs on that floor. To find a position of a mobile device, the mobile device may take RSSI measurements and optionally RTT measurements with respect to observed APs that may be located on different floors. The indoor positioning system may process measurement data from the mobile device to determine the floor location of the mobile device. For example, the AP observed by the mobile device to have the strongest receive signal may be assumed to be on the same floor as the mobile device. The indoor positioning system may use the heat map for the corresponding floor of the AP to determine the 3-D positions of the mobile device.

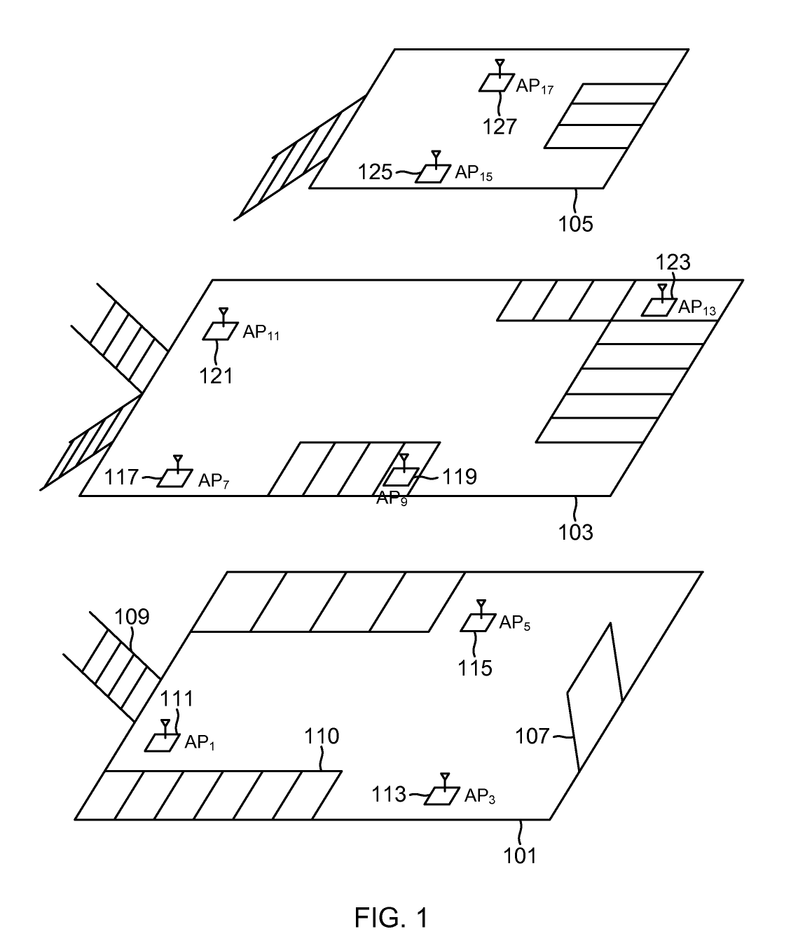

FIG. 1 shows a floor plan view of an indoor venue that has three floors where APs of a WiFi network are deployed for which the floor number of the APs is determined according to one or more embodiments of the subject matter of the present disclosure. APs determined to be on the same floor may be assigned to a cluster so that there may be three clusters of APs, one cluster for each floor. A heat map may be generated for the nodes of a connectivity map for each floor with respect to the APs in the corresponding cluster. A heat map may also be generated for the nodes of a connectivity map for locations between two floors, such as on the stairs, with respect to the APs in the corresponding clusters of the two floors. An indoor positioning system may use the heat maps for the nodes of the connectivity map to determine the position of mobile devices in the indoor venue.

The indoor venue may be an indoor shopping mall, an exhibit hall, a hotel, a sporting venue, or other public or private space. The indoor venue has a first floor 101, a second floor 103, and a third floor 105. A main entrance 107 to the indoor venue is located on first floor 101 and stairs 109 connect the floors. Each floor has a multitude of stores 110, such as those found in an indoor shopping mall. In one or more embodiments, stores 110 may be booths, stalls, etc. First floor 101 has three APs designated as AP₁ (111), AP₃ (113), and AP₅ (115). Second floor 103 has four APs designated as AP₇ (117), AP₉ (119), AP₁₁ (121), and AP₁₃ (123). Third floor 105 has two APs designated as AP₁₅ (125), and AP₁₇ (127). The APs are positioned to provide signal coverage from at least one AP to any location in the indoor venue. Thus, a user at a location may use a mobile device to search for the AP with the strongest signal for use in accessing the WiFi network. As part of the AP search, the user may measure on the mobile device RSSI and RTT data from observed APs. The RSSI and RTT data, as well as the MAC address of the observed APs, may be transmitted by the mobile device to a server of the WiFi-based indoor positioning system. The server may process the measured data to select a heat map for all or a subset of the observed APs and may use the heat map to estimate a position of the mobile device at or near a node of the connectivity map. For example, the server may determine that the APs from which the mobile device received some of the strongest RSSIs are located on one or more floors. The server may select one or more heat maps with respect to the APs on the one or more floors and may select the connectivity map associated with the floors to estimate the position of the mobile device. The server may transmit the estimated position of the mobile device back to the mobile device as assistance data. In one or more embodiments, the server may transmit the one or more heat maps and the connectivity map to the mobile device for the mobile device to estimate its position.

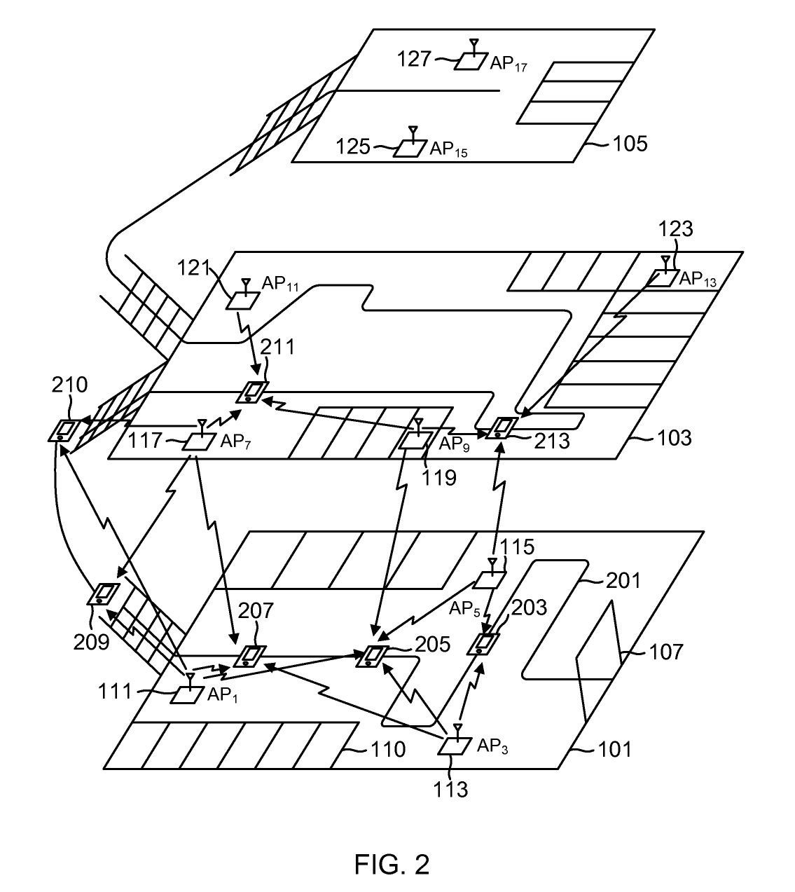

FIG. 2 shows a data collection phase in which measurement data to observed APs are collected at various measurement points along a path according to one or more embodiments of the subject matter of the present disclosure. A data collector may follow a collection path 201 to measure data with respect to observed APs with a mobile device. The mobile device may record RSSI and RTT measurements from observed APs, and the MAC addresses of the APs. The data collector may also enter the location including the floor number and the time at which each measurement is taken. The data collected at the measurement points along collection path 201 are analyzed during the data analysis phase to assign each observed AP to a floor cluster grouping together the APs on the same floor. After the APs in the floor clusters are identified, the data collected with respect to the APs of a floor cluster may be further used to determine a heat map for the nodes of the connectivity map on the floor with respect to the APs. Collection path 201 may be selected to include strategic points such as locations near main entrance 107, in the corridors, near entrance to stores 110, on stairs 109, etc.

The data collected at the measurement points may include measurements made with respect to observed APs on the same floor or on different floors as the mobile device. For example, at measurement point 203 near main entrance 107, the collected data include RSSI and RTT measurements from AP₃ (113) and AP₅ (115) because the mobile device is within range of AP₃ (113) and AP₅ (115) that are located closer to main entrance 107. At measurement point 205, the collected data include RSSI and RTT measurements from AP₁ (111) on first floor 102 and AP₉ (119) on second floor 103, in addition to measurements from AP₃ (113) and AP₅ (115) because the mobile device has come within range of the two new APs. However, the RSSI measured from AP₉ (119) on second floor 103 may be weak because signals received from APs on different floors may be more attenuated than signals from APs of equal distance on the same floor as the measurement point. At measurement point 207, AP₅ (115) and AP₉ (119) are out of range, but AP₇ (117) from second floor 103 has come within range. Therefore, the collected data at measurement point 207 include RSSI and RTT measurements from AP₁ (111), AP₃ (113) on first floor 101, and AP₇ (117) on second floor 103.

Measurement points 209 and 210 are on stairs 109 that connect first floor 101 and second floor 103. At both measurement points, the collected data include RSSI and RTT measurements from AP₁ (111) on first floor 101 and AP₇ (117) on second floor 103. Because measurement point 209 is closer to first floor 101 than to second floor 103, the RSSI measured from AP₁ (111) on first floor 101 may be stronger than the RSSI measured from AP₇ (117) on second floor 103. In contrast, because measurement point 210 is closer to second floor 103 than to first floor 101, the RSSI measured from AP₇ (117) on second floor 103 may be stronger than the RSSI measured from AP₁ (111) on first floor 101. Therefore, by analyzing the direction of change in RSSI measurements with respect to common APs as measurement points move between floors, it is possible to determine the floor number for the APs. In this regard, the data analysis phase may assign AP₁ (111) to the floor cluster for first floor 101 and assign AP₇ (117) to the floor cluster for second floor 103 because the RSSI measurement to AP₇ (117) increases and conversely the RSSI measurement to AP₁ (111) decreases as the measurement points from 209 to 210 move closer to second floor 103 and away from first floor 101.

At measurement point 211, the collected data include RSSI and RTT measurements from AP₇ (117), AP₉ (119), and AP₁₁ (121) on second floor 103. At measurement point 213, the collected data include RSSI and RTT measurements from AP₉ (119), AP₁₃ (123) on second floor 103, and AP₅ (115) on first floor 101. The collected data from the measurement points of FIG. 2 will be used to illustrate a method for AP clustering when the data analysis phase is discussed. The mobile device may transmit the collected data to the server of the indoor positioning system for offline processing. In one or more embodiments, the mobile device may analyze the collected data. In one or more embodiments, the data analysis phase may begin after the data for all the floors have been collected. In one or more embodiments, the server or the mobile devices may analyze the data iteratively after the data on each floor are collected to assign a floor number to the observed APs in the collected data. As more data are collected from additional floors, the additional data may be analyzed to assign a floor number to newly observed APs and also to refine the floor assignment of previously assigned APs.

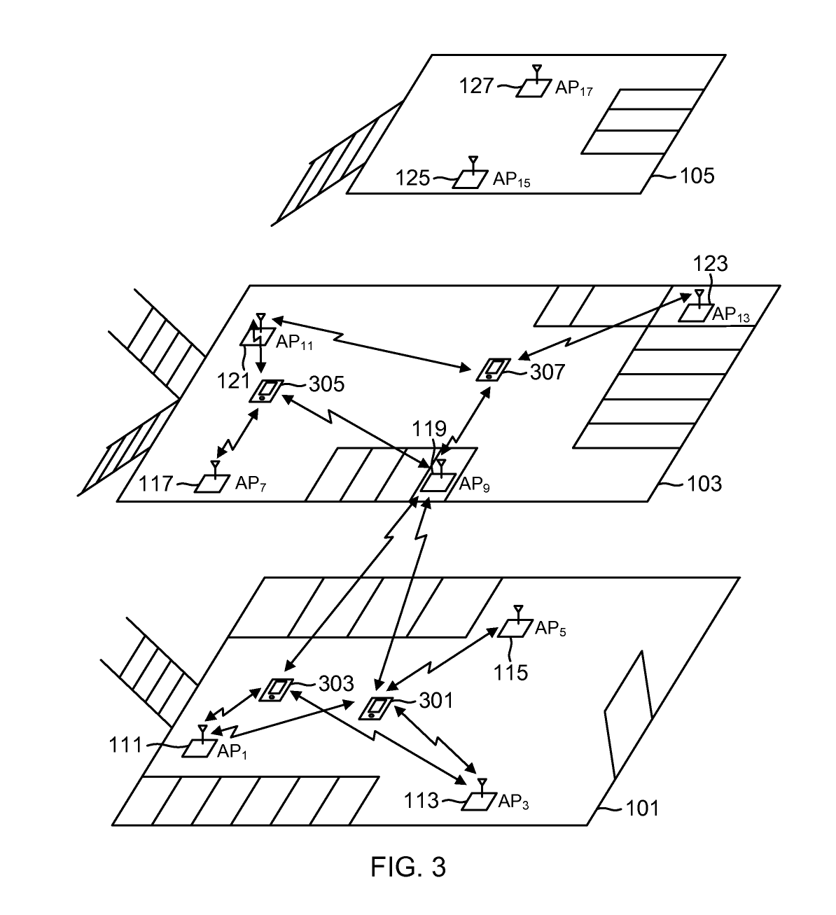

FIG. 3 shows crowd sourced data collected by individual mobile devices as part of a data collection phase according to one or more embodiments of the subject matter of the present disclosure. In crowd sourced data, mobile devices may take RSSI and RTT measurements with respect to observed APs, the MAC addresses of the observed APs, and the time at which the measurements are taken. However, no information is available on the location, such as the floor number, at which the measurements are taken nor is information available on the identity of the mobile devices. The mobile devices may transmit the measured data to one or more of the APs as part of the protocol for establishing connections with the APs. A server of the indoor positioning system may obtain the crowd sourced data from the APs for analysis. The server may leverage the large amount of data collected by a large base of mobile devices to increase the reliability of the assignment of the APs to the floor clusters. In one or more embodiments, crowd sourced data may be analyzed in conjunction with the data collected by data collectors to assign a floor number to a floor cluster by determining the floor number of any one of the APs in the floor cluster.

A first mobile device makes RSSI and RTT measurements at measurement point 301 to AP₁ (111), AP₃ (113), and AP₅ (115) on first floor 101, and to AP₉ (119) on second floor 103. First mobile device may transmit the measurements to any one of the observed APs for recording. In one or more embodiments, first mobile device may transmit the measurements to the AP observed to have the strongest RSSI. A second mobile device makes RSSI and RTT measurements at measurement point 303 to AP₁ (111) and AP₃ (113) on first floor 101, and to AP₉ (119) on second floor 103; a third mobile device makes RSSI and RTT measurements at measurement point 305 to AP₇ (117), AP₉ (119), and AP₁₁ (121) on second floor 103; a fourth mobile device makes RSSI and RTT measurements at measurement point 307 to AP₉ (119), AP₁₁ (121), and AP₁₃ (123) on second floor 103. The crowd sourced data of FIG. 3 will be used to illustrate methods for floor determination of APs when the data analysis phase is discussed.

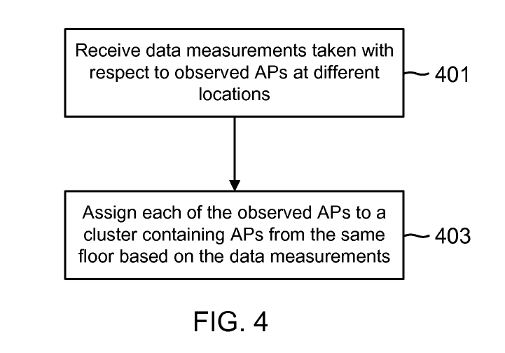

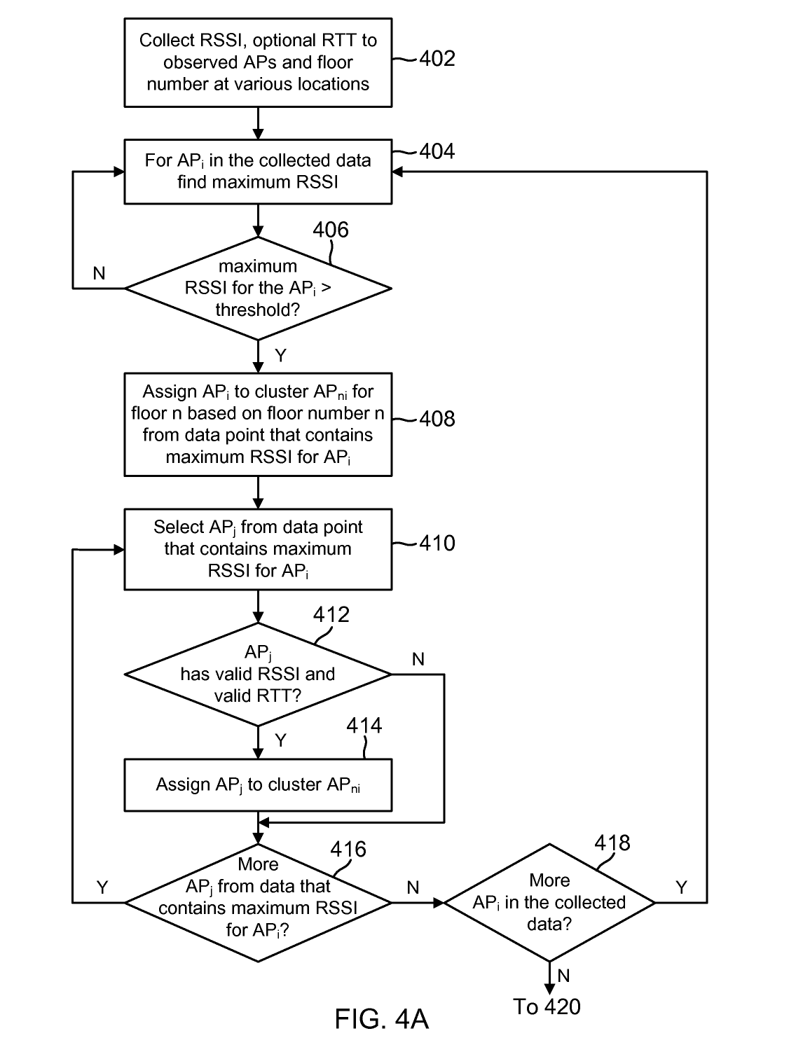

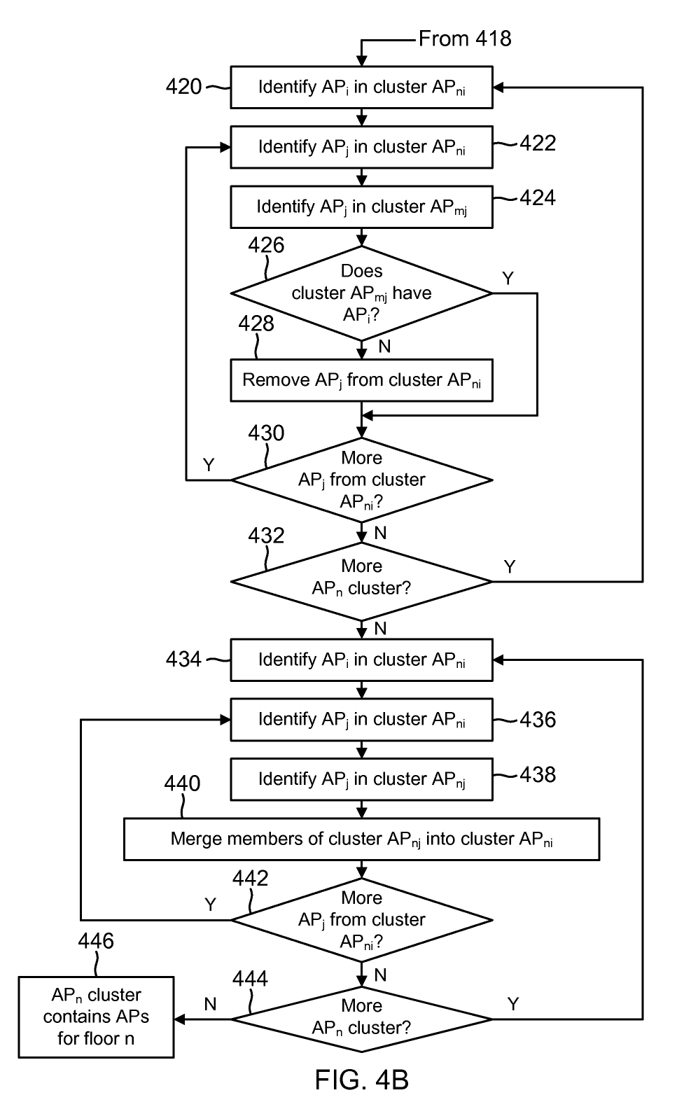

FIG. 4 shows a method for determining the floors on which APs of a WiFi network are located according to one or more embodiments of the subject matter of the present disclosure. In 401, data measurements taken with respect to observed APs from various measurements points are received. The data measurements may be received by the server of the indoor positioning system from APs or from one or more mobile devices that take the data measurements. In one or more embodiments, the data measurements may be received by an AP from mobile devices or from other APs, received by a processor of the same mobile device that takes the data measurements, or received by a mobile device from other mobile devices. The data measurements may be taken by a data collector at measurement points along a collection path or may be taken from crowd sourced data.

In 403, the data measurements are analyzed by the server, an AP, or the mobile device to assign each of the observed APs to a cluster. APs that are determined to be on the same floor are assigned to the same cluster. A cluster may be assigned a floor number if the data measurements include the floor number of the location from which the data measurements are taken. If the data measurements do not include the floor number, a cluster may not be assigned a floor number until the floor number of at least one AP of the cluster is known.

FIGS. 4A and 4B show a method for analyzing collected data to assign observed APs determined to be on the same floor to a cluster according to one embodiment of the subject matter of the present disclosure. The method of FIG. 4A/4B analyzes collected data that include a floor number of the locations at which the data are collected, such as data collected by data collectors, to assign a floor number to the cluster of APs. The method of FIG. 4A/4B may also analyze crowd sourced data to identify clusters of APs belonging to different floors. However, because crowd sourced data do not include floor information of the measurement points, the floor number of the clusters may not be known. A server of an indoor positioning system may analyze the collected data received from one or more mobile devices or from one or more APs. In one or more embodiments, a mobile device or an AP may analyze the collected data. The following discussion uses the measurement data collected from FIG. 2 for analysis by a system server to illustrate the method for clustering APs.

In 402, RSSI measurements and optional RTT measurements are collected to observed APs at various measurement points in the venue. For example, a data collector may use a mobile device to collect measurement data to observed APs at various measurement points along collection path 201 of FIG. 2. The mobile device may also record the floor number at which the measurements are taken when the data collector enters the location including the floor number for each measurement point. For example, the measurement data may include measurement data to AP₃ (113) and AP₅ (115) at first floor 101 for measurement point 203, data to AP₁ (111), AP₃ (113), AP₅ (115), and AP₉ (119) at first floor 101 for measurement point 205, data to AP₁ (111), AP₃ (113), and AP₇ (117) at first floor 101 for measurement point 207, data to AP₁ (111) and AP₇ (117) between first floor 101 and second floor 103 for measurement points 209 and 210, data to AP₇ (117), AP₉ (119), and AP₁₁ (121) at second floor 103 for measurement point 211, and data to AP₅ (115), AP₉ (119), and AP₁₃ (123) at second floor 103 for measurement point 213. The mobile device may transmit the collected data to the system server for processing.

In 404, the method selects an observed AP and searches through the collected data to find the maximum RSSI collected for the selected AP, denoted as APᵢ. For example, the system server may select AP₁ (111) and may search through the collected data to find the maximum RSSI for AP₁ (111). The system server may find the maximum RSSI for AP₁ (111) in the measurement data collected at measurement point 207.

In 406, the maximum RSSI for APᵢ is compared against a first threshold. If the maximum RSSI for APᵢ exceeds the first threshold, in 408, the method obtains the floor number n for the measurement point from which the measurement data containing the maximum RSSI for APᵢ is collected and assigns APᵢ to a cluster APₙᵢ, where APₙᵢ represents a cluster that belongs to APᵢ and is initially assigned to floor n. If the maximum RSSI for APᵢ does not exceed the first threshold, the method goes back to 404 to select another observed AP from the collected data and searches through the collected data to find the maximum RSSI for the newly selected AP. For example, if the maximum RSSI for AP₁ (111) exceeds the first threshold, the system server may obtain the floor number as 1 to represent first floor for measurement points 207 from which the measurement data containing the maximum RSSI for AP₁ (111) is collected. The method may assign AP₁ (111) to cluster AP₁₁ to represent a cluster assigned to floor 1 belonging to AP₁ (111).

In 410, in the measurement data that contains the maximum RSSI for APᵢ, the method selects a second observed AP, denoted as APⱼ to determine if APⱼ has sufficient RSSI and, if available, acceptable RTT for inclusion in the same cluster as APᵢ in APₙᵢ. In 412, the RSSI and optionally the RTT for APⱼ, if available, are tested to determine if the RSSI exceeds a second threshold and optionally if the RTT is within a valid range. If it is, in 414, the method determines that APⱼ is preliminarily on the same floor as APᵢ and assigns APⱼ to cluster APₙᵢ. Otherwise, if the RSSI does not exceed a second threshold or if the RTT is outside a valid range, APⱼ is dropped from further consideration for inclusion in cluster APₙᵢ. For example, the measurement data containing the maximum RSSI for AP₁ (111) collected at measurement point 207 also contains measurements from AP₃ (113), and AP₇ (117). The server may select AP₃ (113) to determine if the RSSI from AP₃ (113) exceeds the second threshold and if the RTT to AP₃ (113) is within a valid range. If the RSSI from AP₃ (113) measured at measurement point 207 exceeds the second threshold and the RTT to AP₃ (113) measured at measurement point 207 is within a valid range, the server may assign AP₃ (113) to cluster AP₁₁. The second threshold may be set to be the same as the first threshold used for comparing against the maximum RSSI for APᵢ in 406. In one or more embodiments, the second threshold may be different from the first threshold.

In 416, the method determines if the measurement data that contains the maximum RSSI for APᵢ has any additional observed AP that has not been considered for inclusion in cluster APₙᵢ. If there is, 410, 412, and 414 are repeated to determine if the RSSI for the additional observed AP exceeds the second threshold and optionally if the RTT for the additional observed AP is within a valid range. If the additional observed AP has sufficient RSSI and, if available, valid RTT the method determines the additional observed AP is preliminarily on the same floor as APᵢ and assigns the additional AP to cluster APₙᵢ. If all the observed APs from the measurement data that contains the maximum RSSI for APᵢ have been considered, the method goes back to 404 to select another observed AP from the collected data and searches through the collected data to find the maximum RSSI for the newly selected AP. 404-416 is repeated until all observed APs have been analyzed to determine if the maximum RSSI for an AP exceeds the first threshold. If the maximum RSSI for the AP exceeds the first threshold, the AP is assigned to its own cluster and the cluster is initially assigned a floor number associated with the measurement point from which the measurement data containing the maximum RSSI for the AP is collected.

For example, the measurement data containing the maximum RSSI for AP₁ (111) collected at measurement point 207 contains AP₇ (117) that has not been considered. If the RSSI from AP₇ (117) measured at measurement point 207 exceeds the second threshold and the RTT to AP₇ (117) measured at measurement point 207 is within a valid range, the server may assign AP₇ (117) to cluster AP₁₁. Therefore, cluster AP₁₁ belonging to AP₁ (111) and assigned to floor 1 may contain AP₃ (113) and AP₇ (117). Similarly, cluster AP₁₃ belonging to AP₃ (113) and assigned to floor 1 may contain AP₁ (111), AP₅ (115), and AP₉ (119), where the measurement data containing the maximum RSSI for AP₃ (113) is collected at measurement point 205 and contains the measurement data to AP₁ (111), AP₅ (115), and AP₉ (119). It is assumed that the RSSIs from AP₁ (111), AP₅ (115), and AP₉ (119) measured at measurement point 205 all exceed the second threshold and the RTTs to AP₁ (111), AP₅ (115), and AP₉ (119) measured at measurement point 205 all are within a valid range. Similarly, cluster AP₁₅ belonging to AP₅ (115) and assigned to floor 1 may contain AP₃ (113), where the measurement data containing the maximum RSSI for AP₅ (115) is collected at measurement point 203 and contains the measurement data to AP₃ (113).

For clusters of APs on second floor 103, cluster AP₂₇ belonging to AP₇ (117) and assigned to floor 2 may contain AP₉ (119) and AP₁₁ (121), where the measurement data containing the maximum RSSI for AP₇ (117) is collected at measurement point 211 and contains the measurement data to AP₉ (119) and AP₁₁ (121). Cluster AP₂₉ belonging to AP₉ (119) and assigned to floor 2 may contain AP₅ (115) and AP₁₃ (123), where the measurement data containing the maximum RSSI for AP₉ (119) is collected at measurement point 213 and contains the measurement data to AP₅ (115) and AP₁₃ (123).

After each APᵢ has been analyzed to determine if the maximum RSSI for the APᵢ exceeds the first threshold and has been assigned to its own cluster APₙᵢ with a floor number n, the method verifies if each APⱼ in cluster APₙᵢ has its own cluster APₘⱼ that includes APᵢ. If the reciprocal relationship for APⱼ and APᵢ does not hold, i.e., APⱼ is assigned to cluster APₙᵢ, but APᵢ is not assigned to cluster APₘⱼ, APⱼ is removed from cluster APₙᵢ. In 420, the method identifies APᵢ from cluster APₙᵢ belonging to APᵢ. In 422, the method identifies APⱼ assigned to cluster APₙᵢ. In 424, the method identifies APⱼ from cluster APₘⱼ belonging to APⱼ. In 426, the method determines if APᵢ has been assigned to cluster APₘⱼ. If APᵢ is not assigned to cluster APₘⱼ, this means that even though the measurement point that receives the maximum RSSI for APᵢ also receives above-threshold RSSI from APⱼ, the measurement point that receives the maximum RSSI for APⱼ does not receive above-threshold RSSI from APᵢ. This suggests that APᵢ may not be on the same floor as APⱼ. The assumption is that if APᵢ and APⱼ are on the same floor, when a mobile device is able to receive strong signal (i.e., RSSI greater than the second threshold) from APⱼ when receiving the maximum signal from APᵢ, there is a strong probability that the mobile device will also receive strong signal from APᵢ (i.e., RSSI greater than the second threshold) when receiving the strongest signal from APⱼ. If this is not the case, in 428, APⱼ is removed from cluster APₙᵢ belonging to APᵢ. Otherwise, APⱼ remains in cluster APₙᵢ.

In one or more embodiments, even if APᵢ is assigned to cluster APₘⱼ, APⱼ, may still be removed from cluster APₙᵢ if cluster APₘⱼ belonging to APⱼ has a different floor number m from the floor number n of APₙᵢ. Therefore, if the maximum RSSI for APᵢ is measured on a different floor from the floor on which the maximum RSSI for APⱼ is measured, it is assumed that APᵢ and APⱼ are on different floors even if APⱼ has been assigned to cluster APₙᵢ and APᵢ has been assigned to cluster APₘⱼ. In 430, the method determines if there is any additional AP assigned to cluster APₙᵢ. If there is, 422-428 is repeated to determine if the additional AP should stay in or be removed from cluster APₙᵢ. In 432, the method determines if there is any other cluster belonging to another AP to verify the reciprocal relationship between the AP and members of its cluster. 420-430 is repeated to determine if APs assigned to the clusters should stay in or be removed from the cluster. Thus, 420-432 parses the clusters belonging to the APs to remove APs that may have been preliminarily assigned to the wrong floor.

For example, cluster AP₁₁ of FIG. 2 belongs to AP₁ (111) has preliminary members AP₃ (113) and AP₇ (117) and is assigned to floor 1. It is desired to test the reciprocal relationship between AP₁ (111) and AP₃ (113), and between AP₁ (111) and AP₇ (117). For AP₃ (113), the system server identifies cluster AP₁₃ belonging to AP₃ (113). Cluster AP₁₃ has preliminary members AP₁ (111), AP₅ (115), and AP₉ (119) and is assigned to floor 1. The system server verifies that AP₁ (111) has been assigned to cluster AP₁₃. Because the reciprocal relationship between AP₁ (111) and AP₃ (113) holds and the floor numbers for clusters AP₁₁ and AP₁₃ are the same, AP₃ (113) remains in cluster AP₁₁. In contrast, for AP₇ (117), the system server identifies cluster AP₂₇ belonging to AP₇ (117). Cluster AP₂₇ has preliminary members AP₉ (119) and AP₁₁ (121) and is assigned to floor 2. However, AP₁ (111) is not a member of Cluster AP₂₇. Therefore, the reciprocal relationship between AP₁ (111) and AP₇ (117) does not hold. In addition, the floor numbers for clusters AP₁₁ and AP₂₇ are different. As such, the system server removes AP₇ (117) from cluster AP₁₁ such that cluster AP₁₁ now has AP₃ (113) only. Performing similar parsing on cluster AP₁₃ belonging to AP₃ (113) removes AP₉ (119) and leaves AP₁ (111), AP₅ (115) as members of cluster AP₁₃. Similarly, cluster AP₁₅ belonging to AP₅ (115) is parsed to leave intact the member AP₃ (113).

After the clusters are parsed to verify the reciprocal relationship between the AP to which a cluster belongs and the members of the cluster, the method merges cluster APₙᵢ having one or more members APⱼ with each cluster APₙⱼ belonging to APⱼ. In 434, the method identifies APᵢ from cluster APₙᵢ belonging to APᵢ. In 436, the method identifies APⱼ assigned to cluster APₙᵢ. In 438, the method identifies APⱼ from cluster APₙⱼ belonging to APⱼ. In 440, APs assigned to cluster APₙⱼ are added to cluster APₙᵢ to merge the two clusters. In one or more embodiments, APs assigned to cluster APₙⱼ are merged into cluster APₙᵢ when the floor numbers for the two clusters are the same. The two clusters are merged because after the clusters are parsed, there is a high confidence that the members of the two clusters are located on the same floor. In 442, the method determines if there is any additional AP assigned to cluster APₙᵢ. If there is, 436-440 is repeated to merge APs assigned to clusters belonging to the additional AP members of APₙᵢ into cluster APₙᵢ. Thus, all APs assigned to clusters belonging to a member of APₙᵢ may be merged into APₙᵢ if the member and APᵢ exhibit reciprocal relationship. In 444, the method determines if there is any other cluster APₙᵢ having one or more members APⱼ where the clusters belonging to the members APⱼ may be merged into cluster APₙᵢ. If there is another cluster, 434-442 is repeated to merge APs assigned to clusters belonging to members APⱼ of cluster APₙᵢ into APₙᵢ. In 446, if there are multiple clusters for the same floor, these clusters may be further merged into one cluster for the entire floor. In one or more embodiments, there may be multiple clusters for different areas of the same floor. The APs of each cluster may be used to generate the heat map for the area of the connectivity map on the floor covered by the cluster.

For example, after the clusters assigned to first floor 101 of FIG. 2 are parsed, cluster AP₁₁ belonging to AP₁ (111) has AP₃ (113); cluster AP₁₃ belonging to AP₃ (113) has AP₁ (111), AP₅ (115); cluster AP₁₅ belonging to AP₅ (115) has AP₃ (113). The system server identifies AP₃ (113) as a member assigned to cluster AP₁₁. The system server identifies that cluster AP₁₃ belonging to AP₃ (113) has members AP₁ (111) and AP₅ (115). The system server merges cluster AP₁₃ into cluster AP₁₁ such that AP₅ (115) is merged into cluster AP₁₁. After the merger, cluster AP₁₁ belonging to AP₁ (111) now has AP₃ (113) and AP₅ (115). For AP₅ (115), the system server further identifies that cluster AP₁₅ belonging to AP₅ (115) has a member AP₃ (113). The system server also merges cluster AP₁₅ into cluster AP₁₁. However, AP₃ (113) is already a member of cluster AP₁₁. Therefore, no new member is added to cluster AP₁₁ when clusters AP₁₁ and AP₁₅ are merged. After the merger of the clusters assigned to floor 1, there is only cluster AP₁₁ that has AP₁ (111), AP₃ (113) and AP₅ (115) in the cluster. The three APs located on first floor 101 have been correctly clustered and may be used to generate the heat map for the connectivity map for areas of first floor 101 covered by the APs. Similarly, cluster AP₂₇ assigned to second floor 103 may have AP₇ (117), AP₉ (119), AP₁₁ (121), and AP₁₃ (123). The four APs located on second floor 103 may be used to generate the heat map for the connectivity map for areas of second floor 103 covered by the APs. Note that the method as described may also operate on crowd sourced data to cluster APs belonging to different floors, albeit with no floor numbers assigned to the clusters.

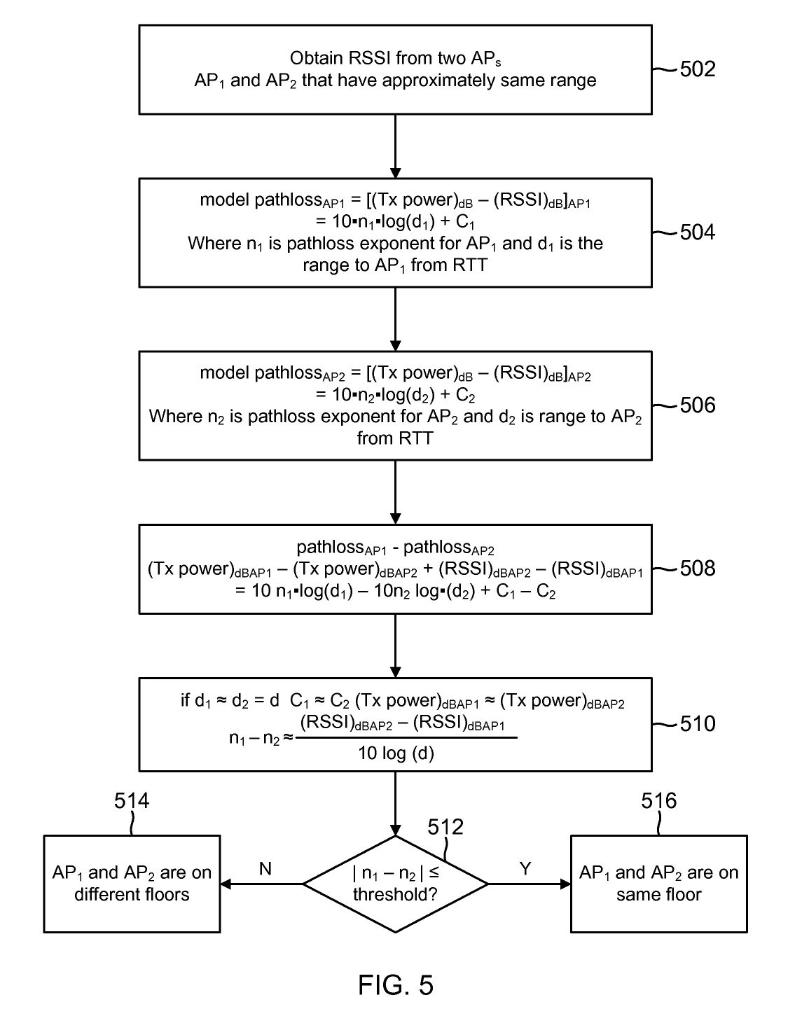

FIG. 5 shows a method for analyzing collected data to determine if two APs are on the same floor or on different floors according to one embodiment of the subject matter of the present disclosure. The method of FIG. 5 may be used when the transmit power from the two APs are assumed to be approximately equal, and when the ranges from a measurement point to the two APs are also approximately equal as determined from the RTT measurement. The method of FIG. 5 may be used to analyze crowd sourced data as well as data collected by data collectors to determine if two APs are on the same floor without assigning a floor number to the APs. In one or more embodiments, once a floor number for one of the two APs is known, such as by the method of FIGS. 4A/4B, the method of FIG. 5 may be used to assign a floor number to the other AP if the two APs are determined to be on the same floor.

In 502, a mobile device collects RSSI measurements and RTT measurements to two APs, denoted as AP₁ and AP₂, at a measurement point in the venue. When the measurements are collected by a data collector, the mobile device may transmit the collected data to a system server for processing or the mobile device may analyze the collected data itself. For crowd sourced data recorded on APs, the APs may transmit the crowd sourced data to the system server for processing. In 504, the path loss from AP₁ to the measurement point is modeled as:

path loss_{AP}_{₁} [symbol] [(Tx power)_{dB}−(RSSI)_{dB}]_{AP}_{₁}=10*n₁*log(d₁)+C₁ (Eq. 1)

In Eq. 1, [(Tx power)_{dB}]_{AP}_{₁} or (Tx power)_{dB AP}_{₁} is the power transmitted by AP₁ expressed in decibel (dB), [(RSSI)_{dB}]_{AP}_{₁} or (RSSI)_{dB AP}_{₁} is the power received from AP₁ in dB at the measurement point as determined from the RSSI measurement, n₁ is a path loss exponent from AP₁ to the measurement point, d₁ is the range from the measurement point to AP₁ as determined from the RTT measurement, and C₁ is a noise term for AP₁. Similarly, in 506, the path loss from AP₂ to the measurement point is modeled as:

path loss_{AP}_{₂} [symbol] [(Tx power)_{dB}−(RSSI)_{dB}]_{AP}_{₂}=10*n₂*log(d₂)+C₂ (Eq. 2)

In Eq. 2, [(Tx power)_{dB}]_{AP}_{₂} or (Tx power)_{dB AP}_{₂} is the power transmitted by AP₂ in db, [(RSSI)_{dB}]_{AP}_{₂} or (RSSI)_{dB AP}_{₂} is the power received from AP₂ in dB at the measurement point as determined from the RSSI measurement, n₂ is a path loss exponent from AP₂ to the measurement point, d₂ is the range from the measurement point to AP₂ as determined from the RTT measurement, and C₂ is a noise term for AP₂.

In 508, the method subtracts the path loss from AP₁ to the measurement point by the path loss from AP₂ to the measurement point to calculate the difference between the two path losses:

path loss_{AP}_{₁}−path loss_{AP}_{₂}=(Tx power)_{dB AP}_{₁}−(Tx power)_{dB AP}_{₂}+(RSSI)_{dB AP}_{₂}−(RSSI)_{dB AP}_{₁}=10*n₁*log(d₁)−10*n₂*log(d₂)+C₁−C₂ (Eq. 3)

In 510, Eq. 3 may be simplified if d₁≈d₂=d, i.e., when the ranges from the measurement point to the two APs are approximately equal. It is assumed that the transmit power from AP₁ and AP₂ are also approximately equal. Hence, (Tx power)_{dB AP}_{₁}≈(Tx power)_{dB AP}_{₂}. C₁ and C₂ are also assumed to be the about the same. Simplifying Eq. 3, the difference between n₁ and n₁ may be expressed as:

$${n}_{1} - {n}_{2} \approx \frac{( {( RSSI )}_{dB {AP}_{2}} - {( RSSI )}_{dB {AP}_{1}} )}{10 * log ( d )} \qquad ( Eq . 4 )$$

If AP₁ and AP₂ are on the same floor, it is expected that the path loss exponent n₁ from AP₁ to the measurement point and the path loss exponent n₂ from AP₂ to the measurement point may be about the same. On the other hand, if AP₁ and AP₂ are on different floors, n₁ and n₂ may be significantly different. Therefore, the difference between n₁ and n₂, as evaluated by Eq. 4, may be used as an indication of whether AP₁ and AP₂ are on the same floor or on different floors. In 512, the absolute value of n₁−n₂, |n₁−n₂|, is compared against a threshold. In 514, if |n₁−n₂| is greater than the threshold, AP₁ and AP₂ are determined to be on different floors. Otherwise, in 516, if |n₁−n₂| is less than or equal to the threshold, AP₁ and AP₂ are determined to be on the same floor. In one or more embodiments, even if d₁ and d₂ are not approximately the same, it may be possible to use Eq. 3 to determine if |n₁−n₂| is sufficiently large such that AP₁ and AP₂ are most likely to be on different floors.

For example, in the crowd sourced data of FIG. 3, a first mobile device at measurement point 301 makes RSSI and RTT measurements to AP₁ (111), AP₃ (113), and AP₅ (115) on first floor 101, and to AP₉ (119) on second floor 103. It may be determined that the ranges from the measurement point to AP₁ (111), AP₃ (113), AP₅ (115), and AP₉ (119) as determined by the RTT measurements are approximately equal. Assume that the transmit power from AP₁ (111), AP₃ (113), AP₅ (115), and AP₉ (119) are approximately equal. |n₁−n₂| may be evaluated from Eq. 4 as the difference in path loss coefficients from AP₁ (111) to the measurement point and from AP₃ (113) to the measurement point. Because |n₁−n₂| is less than the threshold, AP₁ (111) and AP₃ (113) may be determined to be the same floor. Similarly, |n₁−n₂| may be evaluated as the difference in path loss coefficients from AP₃ (113) to the measurement point and from AP₅ (115) to the measurement point. AP₃ (113) and AP₅ (115) may similarly be determined to be on the same floor. On the other hand, |n₁−n₂| evaluated as the difference in path loss coefficients from AP₃ (113) to the measurement point and from AP₉ (119) to the measurement point may be greater than the threshold, since the path loss coefficient may be greater for signal from AP₉ (119) located on a different floor from the measurement point. Therefore, AP₃ (113) and AP₉ (119) may be determined to be on different floors.

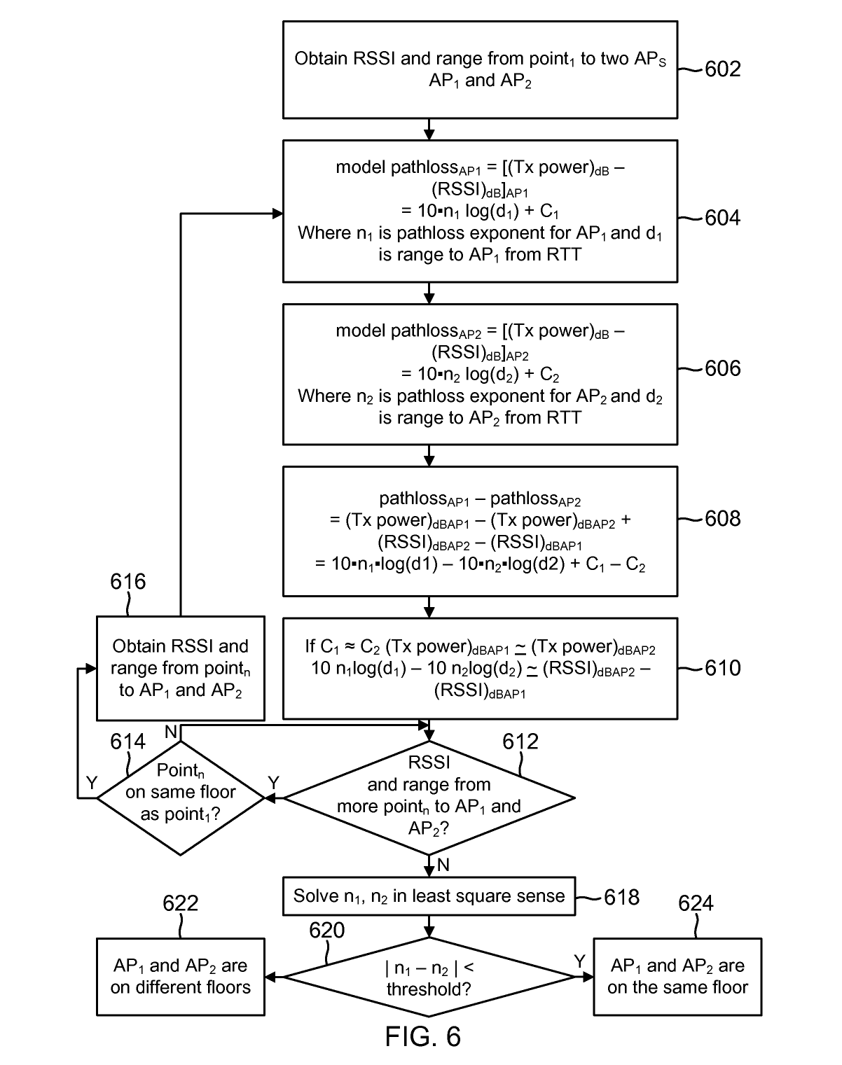

FIG. 6 shows another method for analyzing collected data to determine if two APs are on the same floor or on different floors according to one embodiment of the subject matter of the present disclosure. The method of FIG. 6 may be used when the transmit power from the two APs are assumed to be approximately equal. However, contrary to the method of FIG. 5, there is no restriction on the ranges from a measurement point to the two APs. Similar to the method of FIG. 5, the method of FIG. 6 may be used to analyze crowd sourced data as well as data collected by data collectors to determine if two APs are on the same floor without assigning a floor number to the APs. In one or more embodiments, once a floor number for one of the two APs is known, such as by the method of FIGS. 4A/4B, the method of FIG. 6 may be used to assign a floor number to the other AP if the two APs are determined to be on the same floor.

In 602, a mobile device collects RSSI measurements and RTT measurements to two APs, denoted as AP₁ and AP₂, from several measurement points in the venue. When the measurements are collected by a data collector, the mobile device may transmit the collected data to a system server for processing or the mobile device may analyze the collected data itself. For crowd sourced data, the APs may transmit the recorded crowd sourced data to the system server for processing. In 604, the path loss from AP₁ to a first measurement point is modeled. In 606, the path loss from AP₂ to the first measurement point is modeled. In 608, the difference between the path loss from AP₁ to the measurement point and the path loss from AP₂ to the measurement point is calculated. 604-608 are the same as 504-508 of FIG. 5.

In 610, it is assumed that the transmit power from AP₁ and AP₂ are approximately equal. Hence, (Tx power)_{dB AP}_{₁}≈(Tx power)_{dB AP}_{₂}. C₁ and C₂ are also assumed to be the about the same. Simplifying Eq. 3 yields:

10*n₁*log(d₁)−10*n₂*log(d₂)≈(RSSI)_{dB AP}_{₂}−(RSSI)_{dB AP}_{₁} (Eq. 5)

The path loss exponents n₁ and n₂ may be determined using measurement data for the same pair of APs collected from a number of measurement points. The measurement points may be on the same floor so that the path loss exponent from the same AP to the measurement points does not change. Measurement data that include floor numbers of the measurement points from which the measurement data were taken, such as measurement data collected by data collectors, may be used. For crowd sourced data, there is no information on the locations of the measurement points. However, other methods may be used to determine if a pair of measurement data was taken from two measurement points on the same floor, as will be explained later.

In 612, the method determines if additional RSSI and RTT measurement data to AP₁ and AP₂ are available from other measurement points. In 614, if additional measurement data to AP₁ and AP₂ are available, the method determines if the measurement point from which the additional measurement data was collected is on the same floor as the first measurement point. If the measurement points are on the same floor, in 616, the method obtains the additional RSSI and RTT measurement data to AP₁ and AP₂ for the new measurement point. 604-610 is repeated to calculate Eq. 5 using the additional RSSI and RTT measurement data to AP₁ and AP₂. If the measurement points are not on the same floor, the method searches for measurement data to AP₁ and AP₂ from additional measurement points on the same floor until all such measurement points have been found, or until a sufficient number of measurement points have been obtained. In 618, the method considers the linear equations from Eq. 5 for several of the measurement points on the same floor and solves for n₁ and n₂. For example, the method may solve for n₁ and n₂ in a least square sense. As in FIG. 5, the difference between n₁ and n₂ may be used as an indication of whether AP₁ and AP₂ are on the same floor or on different floors. In 620, the absolute value of n₁−n₂, or |n₁−n₂|, is compared against a threshold. In 622, if |n₁−n₂| is greater than the threshold, AP₁ and AP₂ are determined to be on different floors. Otherwise, in 624, AP₁ and AP₂ are determined to be on the same floor.

For example, in the crowd sourced data of FIG. 3, a first mobile device at measurement point 301 makes RSSI and RTT measurements to AP₁ (111), AP₃ (113) on first floor 101, and to AP₉ (119) on second floor 103. Assume that the transmit power from AP₁ (111), AP₃ (113), and AP₉ (119) are approximately equal. Eq. 5 may be evaluated to calculate the difference in received power at measurement point 301 from AP₁ (111) and AP₃ (113). Eq. 5 may also be evaluated to calculate the difference in received power at measurement point 301 from AP₃ (113) and AP₉ (119). A second mobile device at measurement point 303 also makes RSSI and RTT measurements to AP₁ (111), AP₃ (113) on first floor 101, and to AP₉ (119) on second floor 103. Measurement points 301 and 303 are on first floor 101. Similarly, Eq. 5 may be evaluated to calculate the difference in received power from AP₁ (111) and AP₃ (113), and the difference in received power from AP₃ (113) and AP₉ (119) at measurement point 303. If measurements to AP₁ (111), AP₃ (113), and AP₉ (119) are available from other measurement points on first floor 101, Eq. 5 may similarly be evaluated for the other measurement points.

The system server may solve for n₁ and n₂ for the path loss coefficient from AP₁ (111) and AP₃ (113), respectively, to measurement points on first floor 101 in a least square sense. For example, the system server may solve for n₁ and n₂ using the difference in received power from AP₁ (111) and AP₃ (113) from Eq. 5 evaluated at measurement points 301, 303, and others. The system server may evaluate |n₁−n₂| against the threshold. |n₁−n₂| is expected to be less than the threshold since the path loss coefficients for APs on the same floor may be about the same. Therefore, AP₁ (111) and AP₃ (113) may be determined to be on the same floor. The system server may also solve for n₁ and n₂ for the path loss coefficient from AP₃ (113) and AP₉ (119), respectively, to measurement points on first floor 101 in a least square sense using Eq. 5. However, |n₁−n₂| is expected to be greater than the threshold, since the path loss coefficient measured from first floor 101 may be greater for signal from AP₉ (119) located on second floor 103 than for signal from AP₃ (113) on first floor 101. Therefore, AP₃ (113) and AP₉ (119) may be determined to be on different floors.

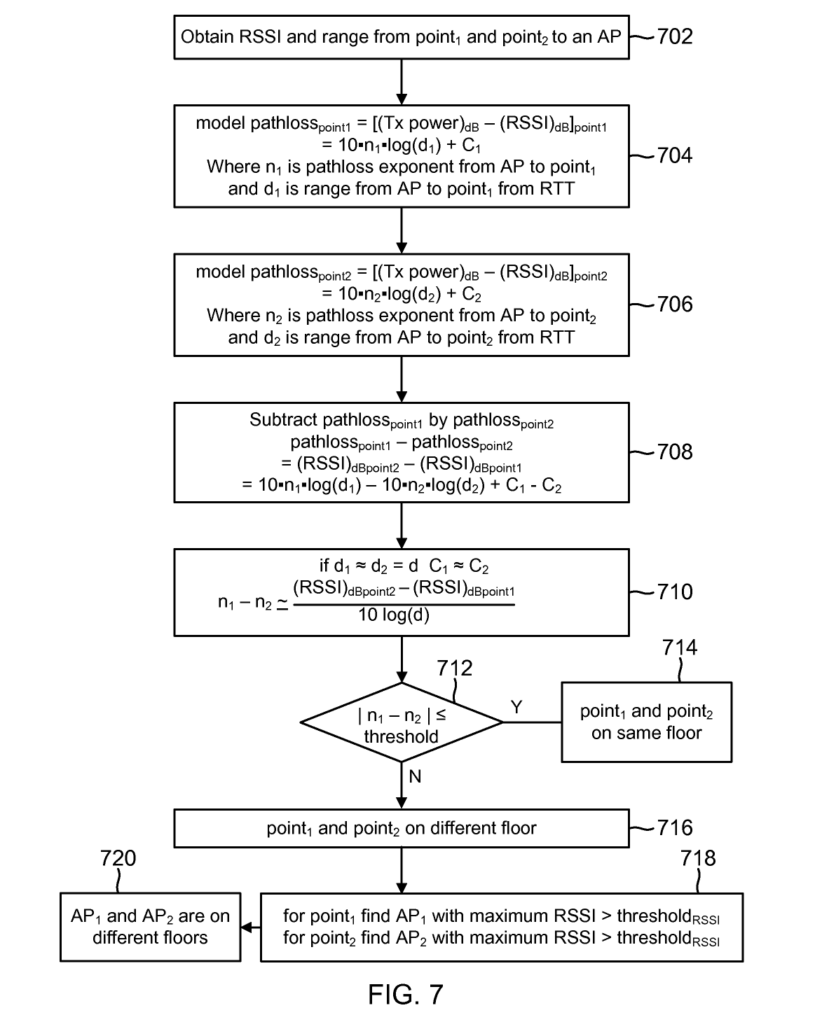

FIG. 7 shows a method for analyzing the collected data to determine if two measurement points are on the same floor or on different floors according to one embodiment of the subject matter of the present disclosure. The method of FIG. 7 may be used when the ranges from two measurement points to a common AP are approximately equal as determined from the RTT measurement. The method of FIG. 7 may be used with crowd sourced data to determine if a pair of measurement points is on the same floor so that measurement data to two APs taken from the two measurement points may be used in the method of FIG. 6. The method of FIG. 7 may also be used in conjunction with the method FIGS. 4A/4B to increase the confidence level on the assignment of APs to the correct clusters. For example, if the method of FIG. 7 determines that two measurement points are on different floors, the measurement data may be analyzed to find the AP that is received with a maximum RSSI above a threshold for each measurement point. The two strongest observed APs for the two measurement points may be assigned to AP clusters on different floors because it may be assumed that the strongest observed AP for a measurement point is on the same floor as the measurement point. Similarly, if the method of FIG. 7 determines that two measurement points are on the same floor, the measurement data may be analyzed to find the AP that is received with a maximum RSSI above a threshold for each measurement point. The two strongest observed APs for the two measurement points may be assigned to the same AP cluster.

In 702, a mobile device collects RSSI and RTT measurements from two measurement points, denoted as point₁ and point₂, to an AP in the venue. For crowd sourced data, the measurements may be collected by different mobile devices and may be recorded on APs. The APs may transmit the collected data to a system server for processing. The system server may select an AP that has an RSSI that exceeds a threshold as measured from one or both of the measurement points. In 704, the path loss from the AP to point₁ is modeled as:

path lossₚₒᵢₙₜ_{₁} [symbol] [(Tx power)_{dB}−(RSSI)_{dB point}_{₁}]=10*n₁*log(d₁)+C₁ (Eq. 6)

In Eq. 6, (Tx power)_{dB} is the power transmitted by the AP in dB, (RSSI)_{dB point}_{₁} is the power received from the AP in dB at point₁ as determined from the RSSI measurement, n₁ is the path loss exponent from the AP to point₁, d₁ is the range from point₁ to the AP as determined from the RTT measurement, and C₁ is a noise term for point₁. Similarly, in 706, the path loss from the AP to point₁ is modeled as:

path lossₚₒᵢₙₜ_{₂} [symbol] [(Tx power)_{dB}−(RSSI)_{dB point}_{₂}]=10*n₂*log(d₂)+C₂ (Eq. 7)

In Eq. 7, (RSSI)_{dB point}_{₂} is the power received from the AP in dB at point₂ as determined from the RSSI measurement, n₂ is the path loss exponent from the AP to point₂, d₂ is the range from point₂ to the AP as determined from the RTT measurement, and C₂ is a noise term for point₂ In 708, the method subtracts the path loss from the AP to point₁ by the path loss from the AP to point₂ to calculate the difference between the two path losses:

path lossₚₒᵢₙₜ_{₁}−path lossₚₒᵢₙₜ_{₂}=(RSSI)_{dB point}_{₂}−(RSSI)_{db point}_{₁}=10*n₁*log(d₁)−10*n₂*log(d₂)+C₁−C₂ (Eq. 8)

In 710, Eq. 8 may be simplified if d₁≈d₁=d, i.e., when the ranges from point₁ and point₂ to the AP are approximately equal. C₁ and C₂ are also assumed to be about the same. Simplifying Eq. 8, the difference between n₁ and n₁ may be expressed as:

$${n}_{1} - {n}_{2} \approx \frac{( {( RSSI )}_{dB {point}_{2}} - {( RSSI )}_{dB {point}_{1}} )}{10 * log ( d )} \qquad ( Eq . 9 )$$

If point₁ and point₂ are on the same floor, it is expected that the path loss exponent n₁ from the AP to point₁ and the path loss exponent n₂ from the AP to point₂ may be about the same. On the other hand, if point₁ and point₂ are on different floors, n₁ and n₂ may be significantly different. Therefore, the difference between n₁ and n₂, as evaluated by Eq. 9, may be used as an indication of whether point₁ and point₂ are on the same floor or on different floors. In 712, the absolute value of n₁−n₂, |n₁−n₂|, is compared against a threshold. In 714, if |n₁−n₂| is less than or equal to the threshold, point₁ and point₂ are determined to be on the same floor. Otherwise, in 716, if |n₁−n₂| is greater than the threshold, point₁ and point₂ are determined to be on different floors. In 718, for point₁ and point₂ that are on different floors, the method finds the AP that is received with a maximum RSSI above a RSSI threshold at each of the two measurement points. For example, signals from AP₁ may have the maximum RSSI among the observed APs measured at point₁ and may also exceed the RSSI threshold. Similarly, signals from AP₂ may have the maximum RSSI among the observed APs at point₂ and may also exceed the RSSI threshold. In 720, AP₁ and AP₂ are assigned to clusters on different floors because it is assumed that AP₁ is on the same floor as point₁ and AP₂ is on the same floor as point₂. 718 may similarly operate on point₁ and point₂ that are determined to be on the same floor to assign the strongest observed APs for point₁ and point₂, AP₁ and AP₂, to the same floor cluster.

For example, in the crowd sourced data of FIG. 3, a first mobile device at measurement point 301 on first floor 101 makes RSSI and RTT measurements to AP₉ (119) on second floor 103. Similarly, a second mobile device at measurement point 303 also on first floor 101 makes RSSI and RTT measurements to the same AP₉ (119). A third mobile device at measurement point 307 on second floor 103 makes RSSI and RTT measurements to the same AP₉ (119). It may be determined that the ranges from measurement points 301, 303, and 307 to AP₉ (119) as determined by the RTT measurements are approximately equal. The system server may evaluate |n₁−n₂| of Eq. 9 to calculate the difference in path loss coefficients from AP₉ (119) to measurement point 301 and from AP₉ (119) to measurement point 303. The system server may compare |n₁−n₂| against the threshold. Because measurements points 301 and 303 are on the same floor, n₁ and n₂, the path loss coefficient from AP₉ (119) to measurement points 301 and the path loss coefficient from AP₉ (119) to measurement points 303, respectively, may be about the same, even if AP₉ (119) is on a different floor from measurement points 301 and 303. Therefore, |n₁−n₂| evaluated for measurement points 301 and 303 is less than the threshold. Accordingly, measurement points 301 and 303 are determined to be on the same floor.

The system server may also evaluate |n₁−n₂| of Eq. 9 to calculate the difference in path loss coefficients from AP₉ (119) to measurement point 301 and from AP₉ (119) to measurement point 307. The path loss coefficient from AP₉ (119) located on second floor 103 to measurement point 301 on first floor 101 may be greater than the path loss coefficient from AP₉ (119) to measurement point 307 also on second floor 103. Therefore, |n₁−n₂| evaluated for measurement points 301 and 307 is expected to be more than the threshold. Accordingly, measurement points 301 and 307 are determined to be on different floors. At measurement point 301, the RSSI measurement from AP₃ (113) may exceed the RSSI threshold and may be the maximum RSSI among the RSSI measurements from the observed APs. At measurement point 307, the RSSI measurement from AP₉ (119) may also exceed the RSSI threshold and may be the maximum RSSI among the RSSI measurements from the observed APs. Because it is assumed that a measurement point receives the strongest RSSI from an AP on the same floor, AP₃ (113) and AP₉ (119) may be assigned to clusters on different floors.

Advantageously, the methods disclosed may be used to assign observed APs to clusters corresponding to different floors using crowd sourced data or data collected by data collectors. If the floor numbers for the measurement points are known, such as when measurement data are collected by data collectors, the methods may determine the floor number for each of the observed APs and to assign the APs to the clusters corresponding to the correct floors. An indoor positioning system may use APs in the cluster for a floor, the measurement data measured from the APs in the cluster and their associated location information to generate the heat map for the nodes of the connectivity maps for that floor.

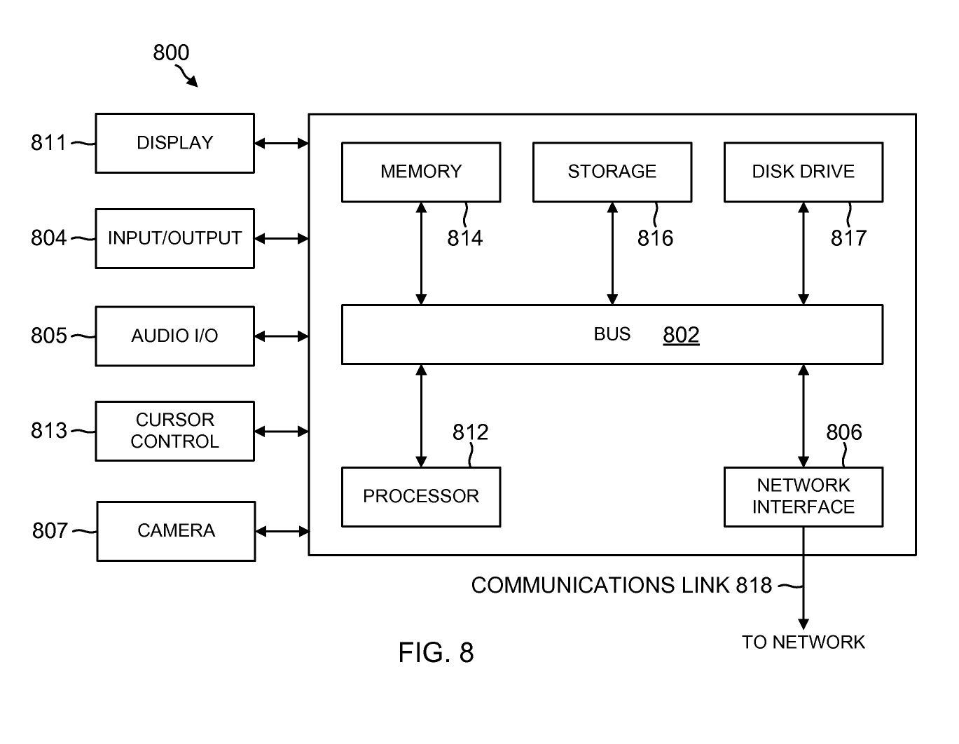

FIG. 8 is a block diagram of a computer system 800 suitable for implementing methods to analyze collected measurement data to assign APs of a WiFi network to floor clusters or to assign floor numbers to APs according to one embodiment of the subject matter of the present disclosure. For example, computer system 800 may be a system server of an indoor positioning system. Computer system 800 may also be a mobile device used to collect measurement data by data collectors to APs or to collect crowd sourced data. Computer system 800 may comprise or implement a plurality of hardware components and/or software components that operate to perform various methodologies in accordance with the described embodiments.

Computer system 800 includes a bus 802 or other communication mechanism for communicating data, signals, and information between various components of computer system 800. Components include an input/output (I/O) component 804 that processes user action and sends a corresponding signal to bus 802. I/O component 804 may also include an output component such as a display 811 for displaying results of the analysis of the collected data, an input component such as a camera 807, and an input control such as a cursor control 813 (such as a virtual keyboard, virtual keypad, virtual mouse, etc.). An optional audio input/output component 805 may also be included to allow a user to use voice for inputting information by converting audio signals into information signals. Audio I/O component 805 may allow the user to hear audio. A transceiver or network interface 806 transmits and receives signals between computer system 800 and other devices, such as receiving collected measurement data from a mobile device, an AP, or another network computing device via a communication link 818 to a network. In one embodiment, the transmission is wireless, although other transmission mediums and methods may also be suitable. A processor 812, which can be a micro-controller, digital signal processor (DSP), or other processing component, processes these various signals, such as for analyzing the collected measurement data received via communication link 818. Processor 812 may also control transmission of information, such the results of the analysis of the measurement data, to other devices.

Components of computer system 800 also include a system memory component 814 (e.g., RAM), a static storage component 816 (e.g., ROM), and/or a disk drive 817. Computer system 800 performs specific operations by processor 812 and other components by executing one or more sequences of instructions contained in system memory component 814. Logic may be encoded in a computer readable medium, which may refer to any medium that participates in providing instructions to processor 812 for execution. Such a medium may take many forms, including but not limited to, non-volatile media, volatile media, and transmission media. In various implementations, non-volatile media includes optical, or magnetic disks, or solid-state drives, such as storage component 816 or disk drive 817; volatile media includes dynamic memory, such as system memory component 814; and transmission media includes coaxial cables, copper wire, and fiber optics, including wires that comprise bus 802. In one example, transmission media may take the form of acoustic or light waves, such as those generated during radio wave, optical, and infrared data communications.

In various embodiments of the present disclosure, execution of instruction sequences to practice the present disclosure may be performed by computer system 800. In various other embodiments of the present disclosure, a plurality of computer systems 800 coupled by communication link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

For example, instructions for the system server of the indoor positioning system to analyze the collected measurement data to assign APs determined to be on the same floor to a cluster may be stored in the computer readable medium of system memory component 814, storage component 816, or disk drive 817 for execution by processor 812. Processor 812 may execute the instructions to receive measurement data from mobile devices, to search through the collected data to find the maximum RSSI for a selected AP, to assign to a cluster the selected AP and other APs with valid RSSI measurements contained in the measurement data that contains the maximum RSSI for the selected AP, to parse clusters of APs, and to merge clusters of APs on the same floor. Processor 812 may also execute the instructions to analyze the collected data to determine if two APs are on the same floor or on different floors, as well as to determine if two measurement points are on the same floor or on different floors.

Where applicable, various embodiments provided by the present disclosure may be implemented using hardware, software, firmware, or combinations thereof. Also where applicable, the various hardware components, software components, and/or firmware components set forth herein may be combined into composite components comprising software, firmware, hardware, and/or all without departing from the spirit of the present disclosure. Where applicable, the various hardware components, software components, and/or firmware components set forth herein may be separated into sub-components comprising software, firmware, hardware, or all without departing from the spirit of the present disclosure. In addition, where applicable, it is contemplated that software components may be implemented as hardware components, and vice-versa. Where applicable, the ordering of various steps described herein may be changed, combined into composite steps, and/or separated into sub-steps to provide features described herein.

For example, computer system 800 may include hardware to compute the difference in path loss coefficients from two APs to a common measurement point, or to compute the difference in path loss coefficients from a common AP to a pair of measurement points of almost identical range. Computer system 800 may also include hardware to accelerate the search through the collected data to find the maximum RSSI for a selected AP. Processor 812 may manage a portion of system memory 814 to facilitate a search through the large amount of data collected by a large base of mobile devices in crowd sourced data.

Although embodiments of the present disclosure have been described, these embodiments illustrate but do not limit the disclosure. For example, although the system and methods described operate on measurement data to determine the floors of APs of a WiFi network, embodiments of the present disclosure may encompass systems and methods operating on measurement data to determine 2-D or 3-D locations of base stations of other types of communication networks. It should also be understood that although the determination of floor numbers of APs are described for indoor positioning systems, embodiments of the present disclosure may encompass determining locations of devices of outdoor positioning systems as well. It is understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

What is claimed is:

1. A method, comprising:
receiving by a processor data measurements with respect to a plurality of access points (APs) of a communication network taken at a plurality of measurement points; and
assigning each of the plurality of APs to one of a plurality of clusters based on the data measurements, wherein each cluster has one or more member APs, and wherein the member APs in each of the clusters are determined to be on the same floor.

2. The method of claim 1, wherein the data measurements taken at each of the measurement points comprise a received signal strength indicator (RSSI) of signals received from each of one or more observable APs, wherein the observable APs are a subset of the plurality of APs.

3. The method of claim 2, wherein the data measurements taken at each of the measurement points further comprise a round trip time (RTT) of signals exchanged between a device at each of the measurement points and each of the observable APs.

4. The method of claim 2, wherein the data measurements taken at each of the measurement points further comprise a floor number for each of the measurement points from where the data measurements are taken.

5. The method of claim 1, wherein said assigning comprises:
generating a plurality of AP clusters, wherein each AP cluster belongs to a selected AP chosen from the plurality of APs and wherein each AP cluster contains one or more member APs preliminarily determined to be on the same floor as the selected AP;
parsing each of the AP clusters to refine the member APs of the AP clusters; and
merging into a selected AP cluster member APs contained in one or more other AP clusters wherein the one or more other AP clusters belong to one or more member APs of the selected AP cluster.

6. The method of claim 5, wherein said generating an AP cluster that belongs to a selected AP comprises:
finding a maximum received signal strength indicator (RSSI) for the selected AP from the data measurements, wherein the maximum RSSI exceeds a first threshold;
assigning the selected AP to the AP cluster, wherein the AP cluster belongs to the selected AP;
selecting from the data measurements that contains the maximum RSSI for the selected AP one or more other APs whose RSSI exceeds a second threshold; and
assigning the one or more other APs as member APs of the AP cluster.

7. The method of claim 6, wherein if the data measurements that contain the maximum RSSI for the selected AP further comprise a floor number from where the data measurements are taken, said generating the AP cluster that belongs to a selected AP further comprises associating the floor number with the AP cluster.

8. The method of claim 6, wherein if the data measurements that contain the maximum RSSI for the selected AP further comprise a round trip time (RTT) between where the data measurements are taken and the one or more other APs, said selecting from the data measurements that contains the maximum RSSI for the selected AP one or more other APs further comprises verifying that the RTT indicates a valid range between where the data measurements are taken and the one or more other APs.

9. The method of claim 5, wherein said parsing an AP cluster to refine the member APs of the AP cluster comprises:
identifying a selected AP to which a first AP cluster belongs;
identifying a member AP of the first AP cluster;
identifying a second AP cluster that belongs to the member AP;
determining if the selected AP is a member AP of the second AP cluster; and
removing the member AP from the first AP cluster if the selected AP is not a member AP of the second AP cluster.

10. The method of claim 9, wherein if the first AP cluster and the second AP cluster have associated floor numbers, said parsing an AP cluster to refine the member APs of the AP cluster further comprises removing the member AP from the first AP cluster if the floor number associated with first AP cluster is different than the floor number associated with the second AP cluster.

11. The method of claim 5, wherein if the AP clusters have associated floor numbers, said merging further comprises merging into the selected AP cluster member APs contained in one or more other AP clusters if a floor number associated with the selected AP cluster is the same as the floor number associated with the one or more other AP clusters.

12. The method of claim 5, wherein said merging into a selected AP cluster member APs contained in one or more other AP clusters comprises generating one of the clusters.

13. The method of claim 1, further comprising assigning a floor number to each of the clusters.

14. The method of claim 1, wherein said assigning comprises:
generating one or more first path loss from a first AP to one or more measurement points using the data measurements taken at the one or more measurement points with respect to the first AP, wherein the one or more measurement points are on the same floor, and wherein the one or more first path loss comprises a first path loss exponent;
generating one or more second path loss from a second AP to the one or more measurement points using the data measurements taken at the one or more measurement points with respect to the second AP, wherein the one or more second path loss comprises a second loss exponent;
subtracting the first path loss by the second path loss for the one or more measurements points to generate one or more differences in the path loss, wherein the first AP and the second AP are assumed to transmit approximately equal power; and
assigning the first AP and the second AP to the clusters based on the one or more differences in the path loss.

15. The method of claim 14, wherein said assigning the first AP and the second AP to the clusters comprises:
estimating a difference between the first path loss exponent and the second path loss exponent from the one or more differences in the path loss;
assigning the first AP and the second AP to the same cluster if the difference between the first path loss exponent and the second path loss exponent is less than or equal to a threshold; and
assigning the first AP and the second AP to different clusters if the difference between the first path loss exponent and the second path loss exponent exceeds a threshold.

16. The method of claim 14, wherein if the data measurements taken at one of the measurement points indicate that a range from the measurement point to the first AP and a range from the measurement point to the second AP are approximately equal, said assigning the first AP and the second AP to the clusters is based on the difference in the path loss for the one measurement point.

17. The method of claim 15, wherein said estimating a difference between the first path loss exponent and the second path loss exponent comprises solving for the first path loss exponent and the second path loss exponent from the one or more differences in the path loss in a least square sense.

18. The method of claim 1, wherein said assigning comprises:
generating a first path loss from an AP to a first measurement point using the data measurements taken at the first measurement point with respect to the AP, wherein the first path loss comprises a first path loss exponent;
generating a second path loss from the AP to a second measurement point using the data measurements taken at the second measurement point with respect to the AP, wherein the second path loss comprises a second path loss exponent, and wherein the data measurements taken at the first measurement point and at the second measurement point indicate that a range from the first measurement point to the AP and a range from the second measurement point to the AP are approximately equal;
subtracting the first path loss by the second path loss to generate a difference in the path loss, wherein the first AP and the second AP are assumed to transmit approximately equal power; and
using the difference in the path loss to assign a strongest observable AP at the first measurement point and a strongest observable AP at the second measurement point to the clusters.

19. The method of claim 18, wherein said using the difference in the path loss further comprises:
estimating a difference between the first path loss exponent and the second path loss exponent from the difference in the path loss;
determining that the first measurement point and the second measurement point are on the same floor if the difference between the first path loss exponent and the second path loss exponent is less than or equal to a threshold; and
determining that the first measurement point and the second measurement point are on different floors if the difference between the first path loss exponent and the second path loss exponent exceeds a threshold.

20. The method of claim 19, wherein said using the difference in the path loss further comprises:
finding from the data measurements a first AP whose received signal strength indicator (RSSI) at the first measurement point is the strongest among RSSIs from all APs observed at the first measurement point;
finding from the data measurements a second AP whose RSSI at the second measurement point is the strongest among RSSIs from all APs observed at the second measurement point;
assigning the first AP and the second AP to the same cluster if the first measurement point and the second measurement point are on the same floor; and
assigning the first AP and the second AP to different clusters if the first measurement point and the second measurement point are on different floors.

21. An apparatus, comprising:
a memory; and
one or more processors coupled to the memory and configured to:
receive data measurements with respect to a plurality of access points (APs) of a communication network taken at a plurality of measurement points; and;
assign each of the plurality of APs to one of a plurality of clusters based on the data measurements, wherein each cluster has one or more member APs, and wherein the member APs in each of the clusters are determined to be on the same floor.

22. The apparatus of claim 21, wherein the data measurements taken at each of the measurement points comprise a received signal strength indicator (RSSI) of signals received from each of one or more observable APs, wherein the observable APs are a subset of the plurality of APs.

23. The apparatus of claim 22, wherein the data measurements taken at each of the measurement points further comprise a round trip time (RTT) of signals exchanged between a device at each of the measurement points and each of the observable APs.

24. The apparatus of claim 22, wherein the data measurements taken at each of the measurement points further comprise a floor number for each of the measurement points from where the data measurements are taken.

25. The apparatus of claim 21, wherein the one or more processors configured to assign by being further configured to:
generate a plurality of AP clusters, wherein each AP cluster belongs to a selected AP chosen from the plurality of APs and wherein each AP cluster contains one or more member APs preliminarily determined to be on the same floor as the selected AP;
parse each of the AP clusters to refine the member APs of the AP clusters; and
merge into a selected AP cluster member APs contained in one or more other AP clusters wherein the one or more other AP clusters belong to one or more member APs of the selected AP cluster.

26. The apparatus of claim 25, wherein the one or more processors configured to generate an AP cluster that belongs to a selected AP by being further configured to:
find a maximum received signal strength indicator (RSSI) for the selected AP from the data measurements, wherein the maximum RSSI exceeds a first threshold;
assign the selected AP to the AP cluster, wherein the AP cluster belongs to the selected AP;
select from the data measurements that contains the maximum RSSI for the selected AP one or more other APs whose RSSI exceeds a second threshold; and
assign the one or more other APs as member APs of the AP cluster.

27. The apparatus of claim 26, wherein if the data measurements that contain the maximum RSSI for the selected AP further comprise a floor number from where the data measurements are taken, the one or more processors configured to generate an AP cluster that belongs to a selected AP by being further configured to associate the floor number with the AP cluster.

28. The apparatus of claim 26, wherein if the data measurements that contain the maximum RSSI for the selected AP further comprise a round trip time (RTT) between where the data measurements are taken and the one or more other APs, the one or more processors configured to select from the data measurements that contains the maximum RSSI for the selected AP one or more other APs by being further configured to verify that the RTT indicates a valid range between where the data measurements are taken and the one or more other APs.

29. The apparatus of claim 25, wherein the one or more processors configured to parse an AP cluster to refine the member APs of the AP cluster by being further configured to:
identify a selected AP to which a first AP cluster belongs;
identify a member AP of the first AP cluster;
identify a second AP cluster that belongs to the member AP;
determine if the selected AP is a member AP of the second AP cluster; and
remove the member AP from the first AP cluster if the selected AP is not a member AP of the second AP cluster.

30. The apparatus of claim 29, wherein if the first AP cluster and the second AP cluster have associated floor numbers, the one or more processors configured to parse an AP cluster to refine the member APs of the AP cluster by being further configured to remove the member AP from the first AP cluster if the floor number associated with first AP cluster is different than the floor number associated with the second AP cluster.

31. The apparatus of claim 25, wherein if the AP clusters have associated floor numbers, the one or more processors configured to merge by being further configured to merge into the selected AP cluster member APs contained in one or more other AP clusters if a floor number associated with the selected AP cluster is the same as the floor number associated with the one or more other AP clusters.

32. The apparatus of claim 25, wherein the one or more processors configured to merge into a selected AP cluster member APs contained in one or more other AP clusters by being further configured to generate one of the clusters.

33. The apparatus of claim 21, wherein the one or more processors are further configured to assign a floor number to each of the clusters.

34. The apparatus of claim 21, wherein the one or more processors configured to assign by being further configured to:
generate one or more first path loss from a first AP to one or more measurement points from the data measurements taken at the one or more measurement points with respect to the first AP, wherein the one or more measurement points are on the same floor, and wherein the one or more first path loss comprises a first path loss exponent;
generate one or more second path loss from a second AP to the one or more measurement points from the data measurements taken at the one or more measurement points with respect to the second AP, wherein the one or more second path loss comprises a second loss exponent;
subtract the first path loss by the second path loss for the one or more measurements points to generate one or more differences in the path loss, wherein the first AP and the second AP are assumed to transmit approximately equal power; and
assign the first AP and the second AP to the clusters based on the one or more differences in the path loss.

35. The apparatus of claim 34, wherein the one or more processors configured to assign the first AP and the second AP to the clusters by being further configured to:
estimate a difference between the first path loss exponent and the second path loss exponent from the one or more differences in the path loss;
assign the first AP and the second AP to the same cluster if the difference between the first path loss exponent and the second path loss exponent is less than or equal to a threshold; and
assign the first AP and the second AP to different clusters if the difference between the first path loss exponent and the second path loss exponent exceeds a threshold.

36. The apparatus of claim 34, wherein if the data measurements taken at one of the measurement points indicate that a range from the measurement point to the first AP and a range from the measurement point to the second AP are approximately equal, the one or more processors configured to assign the first AP and the second AP to the clusters by being further configured to assign the first AP and the second AP to the clusters based on the difference in the path loss for the one measurement point.

37. The apparatus of claim 35, wherein the one or more processors configured to estimate a difference between the first path loss exponent and the second path loss exponent by being further configured to solve for the first path loss exponent and the second path loss exponent from the one or more differences in the path loss in a least square sense.

38. The apparatus of claim 21, wherein the one or more processors configured to assign by being further configured to:
generate a first path loss from an AP to a first measurement point using the data measurements taken at the first measurement point with respect to the AP, wherein the first path loss comprises a first path loss exponent;
generate a second path loss from the AP to a second measurement point using the data measurements taken at the second measurement point with respect to the AP, wherein the second path loss comprises a second path loss exponent, and wherein the data measurements taken at the first measurement point and at the second measurement point indicate that a range from the first measurement point to the AP and a range from the second measurement point to the AP are approximately equal;
subtract the first path loss by the second path loss to generate a difference in the path loss, wherein the first AP and the second AP are assumed to transmit approximately equal power; and
use the difference in the path loss to assign a strongest observable AP at the first measurement point and a strongest observable AP at the second measurement point to the clusters.

39. The apparatus of claim 38, wherein the one or more processors configured to use the difference in the path loss by being further configured to:
estimate a difference between the first path loss exponent and the second path loss exponent from the difference in the path loss;
determine that the first measurement point and the second measurement point are on the same floor if the difference between the first path loss exponent and the second path loss exponent is less than or equal to a threshold; and
determine that the first measurement point and the second measurement point are on different floors if the difference between the first path loss exponent and the second path loss exponent exceeds a threshold.

40. The apparatus of claim 39, wherein the one or more processors configured to use the difference in the path loss by being further configured to:
find from the data measurements a first AP whose received signal strength indicator (RSSI) at the first measurement point is the strongest among RSSIs from all APs observed at the first measurement point;
find from the data measurements a second AP whose RSSI at the second measurement point is the strongest among RSSIs from all APs observed at the second measurement point;
assign the first AP and the second AP to the same cluster if the first measurement point and the second measurement point are on the same floor; and
assign the first AP and the second AP to different clusters if the first measurement point and the second measurement point are on different floors.

41. A non-transitory computer-readable medium comprising a plurality of machine-readable instructions which, when executed by one or more processors, are adapted to cause the one or more processors to perform a method, comprising:
receiving data measurements with respect to a plurality of access points (APs) of a communication network taken at a plurality of measurement points; and
assigning each of the plurality of APs to one of a plurality of clusters based on the data measurements, wherein each cluster has one or more member APs, and wherein the member APs in each of the clusters are determined to be on the same floor.

42. The non-transitory computer-readable medium of claim 41, wherein the data measurements taken at each of the measurement points comprise a received signal strength indicator (RSSI) of signals received from each of one or more observable APs, wherein the observable APs are a subset of the plurality of APs.

43. The non-transitory computer-readable medium of claim 41, wherein said assigning comprises:
generating a plurality of AP clusters, wherein each AP cluster belongs to a selected AP chosen from the plurality of APs and wherein each AP cluster contains one or more member APs preliminarily determined to be on the same floor as the selected AP;
parsing each of the AP clusters to refine the member APs of the AP clusters; and
merging into a selected AP cluster member APs contained in one or more other AP clusters wherein the one or more other AP clusters belong to one or more member APs of the selected AP cluster.

44. The non-transitory computer-readable medium of claim 43, wherein said generating an AP cluster that belongs to a selected AP comprises:
finding a maximum received signal strength indicator (RSSI) for the selected AP from the data measurements, wherein the maximum RSSI exceeds a first threshold;
assigning the selected AP to the AP cluster, wherein the AP cluster belongs to the selected AP;
selecting from the data measurements that contains the maximum RSSI for the selected AP one or more other APs whose RSSI exceeds a second threshold; and
assigning the one or more other APs as member APs of the AP cluster.

45. The non-transitory computer-readable medium of claim 43, wherein said parsing an AP cluster to refine the member APs of the AP cluster comprises:
identifying a selected AP to which a first AP cluster belongs;
identifying a member AP of the first AP cluster;
identifying a second AP cluster that belongs to the member AP;
determining if the selected AP is a member AP of the second AP cluster; and
removing the member AP from the first AP cluster if the selected AP is not a member AP of the second AP cluster.

46. The non-transitory computer-readable medium of claim 41, wherein said assigning comprises:
generating one or more first path loss from a first AP to one or more measurement points using the data measurements taken at the one or more measurement points with respect to the first AP, wherein the one or more measurement points are on the same floor, wherein the one or more first path loss comprises a first path loss exponent, and wherein the data measurements further comprise information on a range between each of the one or more measurement points and the first AP;
generating one or more second path loss from a second AP to the one or more measurement points using the data measurements taken at the one or more measurement points with respect to the second AP, wherein the one or more second path loss comprises a second loss exponent, and wherein the data measurements further comprise information on a range between each of the one or more measurement points and the second AP;
subtracting the first path loss by the second path loss for the one or more measurements points to generate one or more differences in the path loss, wherein the first AP and the second AP are assumed to transmit approximately equal power; and
assigning the first AP and the second AP to the clusters based on the one or more differences in the path loss.

47. The non-transitory computer-readable medium of claim 41, wherein said assigning comprises:
generating a first path loss from an AP to a first measurement point using the data measurements taken at the first measurement point with respect to the AP, wherein the first path loss comprises a first path loss exponent, and wherein the data measurements taken at the first measurement point further comprise information on a range from the first measurement points to the AP;
generating a second path loss from the AP to a second measurement point using the data measurements taken at the second measurement point with respect to the AP, wherein the second path loss comprises a second path loss exponent, wherein the data measurements taken at the second measurement point further comprise information on a range from the second measurement points to the AP, and wherein the range from the first measurement point to the AP and the range from the second measurement point to the AP are approximately equal;
subtracting the first path loss by the second path loss to generate a difference in the path loss, wherein the first AP and the second AP are assumed to transmit approximately equal power; and
using the difference in the path loss to assign a strongest observable AP at the first measurement point and a strongest observable AP at the second measurement point to the clusters.

48. A system, comprising:
means for receiving data measurements with respect to a plurality of access points (APs) of a communication network taken at a plurality of measurement points; and
means for assigning each of the plurality of APs to one of a plurality of clusters based on the data measurements, wherein each cluster has one or more member APs, and wherein the member APs in each of the clusters are determined to be on the same floor.

49. The system of claim 48, wherein the data measurements taken at each of the measurement points comprise a received signal strength indicator (RSSI) of signals received from each of one or more observable APs, wherein the observable APs are a subset of the plurality of APs.

50. The system of claim 48, wherein the means for assigning further comprises:
means for generating a plurality of AP clusters, wherein each AP cluster belongs to a selected AP chosen from the plurality of APs and wherein each AP cluster contains one or more member APs preliminarily determined to be on the same floor as the selected AP;
means for parsing each of the AP clusters to refine the member APs of the AP clusters; and
means for merging into a selected AP cluster member APs contained in one or more other AP clusters wherein the one or more other AP clusters belong to one or more member APs of the selected AP cluster.

51. The system of claim 50, wherein the means for generating an AP cluster that belongs to a selected AP further comprises:
means for finding a maximum received signal strength indicator (RSSI) for the selected AP from the data measurements, wherein the maximum RSSI exceeds a first threshold;
means for assigning the selected AP to the AP cluster, wherein the AP cluster belongs to the selected AP;
means for selecting from the data measurements that contains the maximum RSSI for the selected AP one or more other APs whose RSSI exceeds a second threshold; and
means for assigning the one or more other APs as member APs of the AP cluster.

52. The system of claim 50, wherein the means for parsing an AP cluster to refine the member APs of the AP cluster further comprises:
means for identifying a selected AP to which a first AP cluster belongs;
means for identifying a member AP of the first AP cluster;
means for identifying a second AP cluster that belong to the member AP;
means for determining if the selected AP is a member AP of the second AP cluster; and
means for removing the member AP from the first AP cluster if the selected AP is not a member AP of the second AP cluster.

53. The system of claim 48, wherein the means for assigning further comprises:
means for generating one or more first path loss from a first AP to one or more measurement points using the data measurements taken at the one or more measurement points with respect to the first AP, wherein the one or more measurement points are on the same floor, wherein the one or more first path loss comprises a first path loss exponent, and wherein the data measurements further comprise information on a range between each of the one or more measurement points and the first AP;
means for generating one or more second path loss from a second AP to the one or more measurement points using the data measurements taken at the one or more measurement points with respect to the second AP, wherein the one or more second path loss comprises a second loss exponent, and wherein the data measurements further comprise information on a range between each of the one or more measurement points and the second AP;
means for subtracting the first path loss by the second path loss for the one or more measurements points to generate one or more differences in the path loss, wherein the first AP and the second AP are assumed to transmit approximately equal power; and
means for assigning the first AP and the second AP to the clusters based on the one or more differences in the path loss.

54. The system of claim 48, wherein the means for assigning further comprises:
means for generating a first path loss from an AP to a first measurement point using the data measurements taken at the first measurement point with respect to the AP, wherein the first path loss comprises a first path loss exponent, and wherein the data measurements taken at the first measurement point further comprise information on a range from the first measurement points to the AP;
means for generating a second path loss from the AP to a second measurement point using the data measurements taken at the second measurement point with respect to the AP, wherein the second path loss comprises a second path loss exponent, wherein the data measurements taken at the second measurement point further comprise information on a range from the second measurement points to the AP, and wherein the range from the first measurement point to the AP and the range from the second measurement point to the AP are approximately equal;
means for subtracting the first path loss by the second path loss to generate a difference in the path loss, wherein the first AP and the second AP are assumed to transmit approximately equal power; and
means for using the difference in the path loss to assign a strongest observable AP at the first measurement point and a strongest observable AP at the second measurement point to the clusters.
